(19) United States
(12) Patent Application Publication
(10) Pub. No.: US 2013/0284039 A1
(43) Pub. Date: Oct. 31, 2013

(54) RESIN COMPOSITION FOR LASER ENGRAVING, FLEXOGRAPHIC PRINTING PLATE PRECURSOR FOR LASER ENGRAVING AND PROCESS FOR PRODUCING SAME, AND FLEXOGRAPHIC PRINTING PLATE AND PROCESS FOR MAKING SAME

(71) Applicant: FUJIFILM CORPORATION, Tokyo (JP)

(72) Inventor: Atsushi SUGASAKI, Haibara-gun (JP)

(73) Assignee: FUJIFILM Corporation, Tokyo (JP)

(21) Appl. No.: 13/865,738

(22) Filed: Apr. 18, 2013

(30) Foreign Application Priority Data
Apr. 27, 2012 (JP) 2012-103083

(51) Int. Cl. C08L 53/00; C08K 3/04

(52) U.S. Cl. CPC C08L 53/00; C08K 3/04
USPC 101/395; 525/299; 524/533; 264/400

(57) ABSTRACT

A resin composition for laser engraving that comprises (Component A) a block copolymer comprising a main chain skeleton obtained by step-growth polymerization and a main chain skeleton obtained by chain-growth polymerization; (Component B) a polymerizable compound; and (Component C) a polymerization initiator.

### TECHNICAL FIELD

The present invention relates to a resin composition for laser engraving, a flexographic printing plate precursor for laser engraving and a process for producing the same, and a flexographic printing plate and a process for making the same.

### BACKGROUND ART

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder. With regard to the laser for use in the method, a high-power carbon dioxide laser is generally used. In the case of the carbon dioxide laser, all organic compounds can absorb the irradiation energy and convert it into heat. On the other hand, inexpensive and small-sized semiconductor lasers have been developed, wherein, since they emit visible lights and near infrared lights, it is necessary to absorb a laser light and convert it into heat.

As a resin composition for laser engraving, those described in JP-A-2008-266553 (JP-A denotes a Japanese unexamined patent application publication), JP-A-2009-132150, Japanese Patent No. 3801592, or JP-A-2004-262136 are known.

### DISCLOSURE OF THE PRESENT INVENTION

### Problems that the Present Invention is to Solve

It is an object of the present invention to provide a resin composition for laser engraving that can give a flexographic printing plate having high engraving sensitivity, good rinsing properties for engraving residue, and excellent printing durability and swelling inhibition properties for an aqueous ink and a solvent ink, a flexographic printing plate precursor employing the resin composition for laser engraving and a process for producing same, a process for making a flexographic printing plate using same, and a flexographic printing plate obtained thereby.

### Means for Solving the Problems

The object of the present invention has been attained by means described in <1>, <10> to <12>, <14>, and <15> below. They are described below together with <2> to <9> and <13>, which are preferred embodiments.

<1> A resin composition for laser engraving, comprising (Component A) a block copolymer comprising a main chain skeleton obtained by step-growth polymerization and a main chain skeleton obtained by chain-growth polymerization, (Component B) a polymerizable compound, and (Component C) a polymerization initiator,
<2> the resin composition for laser engraving according to <1> above, wherein Component A is a block copolymer comprising a structure selected from the group consisting of structures represented by P-I to P-V and P′-I to P′-V below

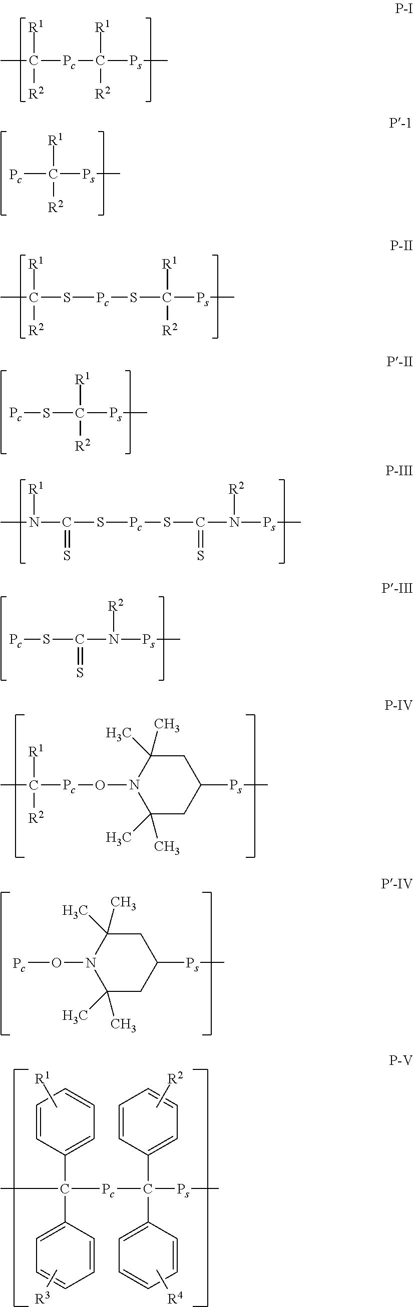

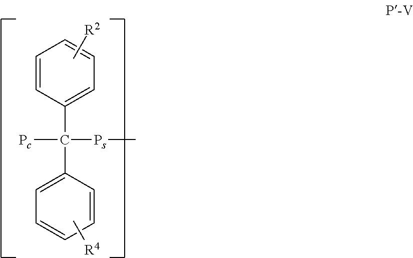

(in the Formulae, Ps denotes a main chain skeleton obtained by step-growth polymerization, Pc denotes a main chain skeleton obtained by chain-growth polymerization, and R¹ to R⁴ independently denote a hydrogen atom, a halogen atom, or a monovalent organic group),
<3> the resin composition for laser engraving according to <1> or <2> above, wherein the main chain skeleton obtained by chain-growth polymerization is a skeleton obtained by chain-growth polymerization of an ethylenically unsaturated compound selected from the group consisting of an acrylic acid ester, a methacrylic acid ester, a styrene, and acrylonitrile,
<4> the resin composition for laser engraving according to any one of <1> to <3> above, wherein the main chain skeleton obtained by step-growth polymerization is a skeleton selected from the group consisting of a polyester skeleton, a polyurethane skeleton, a polyurethane urea skeleton, a polyamide skeleton, a polyalkylene glycol skeleton, and a polysiloxane skeleton,
<5> the resin composition for laser engraving according to any one of <1> to <4> above, wherein Component B comprises a (meth)acrylate derivative and a compound comprising at least one type from a hydrolyzable silyl group and a silanol group,
<6> the resin composition for laser engraving according to any one of <1> to <5> above, wherein Component C comprises an organic peroxide and a silane coupling catalyst,
<7> the resin composition for laser engraving according to any one of <1> to <6> above, wherein Component B comprises a (meth)acrylate derivative and a compound comprising at least one type from a hydrolyzable silyl group and a silanol group, and Component C comprises an organic peroxide and a silane coupling catalyst,
<8> the resin composition for laser engraving according to any one of <1> to <7> above, wherein the resin composition further comprises (Component D) a photothermal conversion agent,
<9> the resin composition for laser engraving according to <8> above, wherein Component D is carbon black,
<10> a flexographic printing plate precursor for laser engraving, comprising a relief-forming layer comprising the resin composition for laser engraving according to any one of <1> to <9> above,
<11> a flexographic printing plate precursor for laser engraving, comprising a crosslinked relief-forming layer formed by crosslinking by means of light and/or heat a relief-forming layer comprising the resin composition for laser engraving according to any one of <1> to <9> above, <12> a process for producing a flexographic printing plate precursor for laser engraving, comprising a layer formation step of forming a relief-forming layer comprising the resin composition for laser engraving according to any one of <1> to <9> above and a crosslinking step of crosslinking the relief-forming layer by means of light and/or heat to thus obtain a flexographic printing plate precursor comprising a crosslinked relief-forming layer,
<13> the process for producing a flexographic printing plate precursor for laser engraving according to <12> above, wherein the crosslinking step is a step of crosslinking the relief-forming layer by means of heat to thus obtain a flexographic printing plate precursor comprising a crosslinked relief-forming layer,
<14> a process for making a flexographic printing plate, comprising an engraving step of laser engraving a flexographic printing plate precursor for laser engraving comprising a crosslinked relief-forming layer formed by crosslinking by means of light and/or heat a relief-forming layer comprising the resin composition for laser engraving according to any one of <1> to <9> above, to thus form a relief layer, and
<15> a flexographic printing plate comprising a relief layer made by the process for making a flexographic printing plate according to <14> above.

### Mode for Carrying Out the Invention

the present invention is explained in detail below.

In the present specification, the notation ‘xx to yy’ means a numerical range that includes xx and yy. Furthermore, ‘(Component A) a block copolymer comprising a main chain skeleton obtained by step-growth polymerization and a main chain skeleton obtained by chain-growth polymerization’, etc. is also simply called ‘Component A’, etc.

The term ‘(meth)acrylate’, etc. has the same meaning as ‘acrylate and/or methacrylate’, etc., and the same applies below.

Furthermore, in the present invention, ‘mass %’ and ‘wt %’ have the same meaning, and ‘parts by mass’ and ‘parts by weight’ have the same meaning.

### (Resin Composition for Laser Engraving)

The resin composition for laser engraving of the present invention (hereinafter, also called simply a ‘resin composition’) comprises (Component A) a block copolymer comprising a main chain skeleton obtained by step-growth polymerization and a main chain skeleton obtained by chain-growth polymerization, (Component B) a polymerizable compound, and (Component C) a polymerization initiator.

The resin composition for laser engraving of the present invention may be applied to a wide range of uses where it is subjected to laser engraving, in addition to use as a relief-forming layer of a flexographic printing plate precursor, without particular limitations. For example, it may be applied not only to a relief-forming layer of a printing plate precursor where formation of a raised relief is carried out by laser engraving, which is explained in detail below, but also to the formation of various types of printing plates or various types of moldings in which image formation is carried out by laser engraving, such as another material form having asperities or openings formed on the surface such as for example an intaglio printing plate, a stencil printing plate, or a stamp.

Among them, the application thereof to the formation of a relief-forming layer provided on an appropriate support is a preferred embodiment.

In the resin composition of the present invention, the mechanism of action due to the use of Component A to Component C is assumed to be as described below.

The main chain skeleton obtained by step-growth polymerization and the main chain skeleton obtained by chain-growth polymerization in Component A form a hard segment and a soft segment respectively (or a soft segment and a hard segment respectively), thus giving a film having a segment structure necessary for tough film strength and high rubber elasticity. It is surmised that this enables performance suitable for flexographic printing (printing durability in particular) to be exhibited. It is also surmised that due to crosslinking with Components B and C as well, the film strength and rubber elasticity further improve, the permeation of an aqueous ink or a solvent ink into the film can be suppressed, swelling due to an ink is therefore inhibited, and the printing durability with various types of ink improves. Furthermore, it is surmised that the reason for high engraving sensitivity is due to the high thermal decomposability of a urethane bond, an ester bond, or an amide bond in the skeleton obtained by step-growth polymerization and the high efficiency of thermal decomposition of the skeleton obtained by chain-growth polymerization in accordance with a mechanism for depolymerization. It is also surmised that the reason for superior rinsing properties for engraving residue is due, as described above, to the high thermal decomposability of Component A at the time of laser engraving, resulting in a reduction in the molecular weight of engraving residue components and an increase in the volatility of engraving residue, thus reducing the amount of engraving residue remaining on a printing plate.

In the present specification, with respect to an explanation of the flexographic printing plate precursor, a non-crosslinked crosslinkable layer comprising Component A to Component C and having a flat surface as an image formation layer that is subjected to laser engraving is called a relief-forming layer, a layer that is formed by crosslinking the relief-forming layer is called a crosslinked relief-forming layer, and a layer that is formed by subjecting this to laser engraving so as to form asperities on the surface is called a relief layer.

Components contained in the resin composition for laser engraving of the present invention are explained below.

### (Component A) Block Copolymer Comprising Main Chain Skeleton Obtained by Step-Growth Polymerization and Main Chain Skeleton Obtained by Chain-Growth Polymerization

The resin composition for laser engraving of the present invention comprises (Component A) a block copolymer comprising a main chain skeleton obtained by step-growth polymerization and a main chain skeleton obtained by chain-growth polymerization.

In the present invention, ‘main chain’ means the longest bonded chain, among chains, of a macro compound molecule constituting a resin, ‘side chain’ means a carbon chain branching from the main chain, and the main chain and/or side chain may comprise a heteroatom. Furthermore, Component A is a polymer and has a number-average molecular weight of at least 1,000, and preferably at least 5,000.

The step-growth polymerization referred to here is polymerization, represented by a polycondensation reaction and a polyaddition reaction, that progresses by repetition of a so-called step reaction in which a reaction product serves as a reagent for a following step and a series of elementary reactions between reactive functional groups occur in succession, and the chain-growth polymerization referred to here is polymerization in which an active structure of a polymerization initiator repeatedly undergoes an addition reaction to a monomer.

Furthermore, step-growth polymerization and chain-growth polymerization are described in for example ‘Kiso Kobunshi Kagaku’ (Basic Polymer Science) edited by the Society of Polymer Science, Japan, 2^{nd} edition, 2006, Tokyo Kagaku Dojin.

The main chain skeleton obtained by step-growth polymerization is preferably a skeleton obtained by polyaddition or polycondensation, and more preferably a skeleton obtained by polyaddition.

The main chain skeleton obtained by chain-growth polymerization is preferably a skeleton obtained by polymerization of a radically polymerizable monomer, and more preferably a skeleton obtained by polymerization of an ethylenically unsaturated compound.

Furthermore, the main chain skeleton obtained by step-growth polymerization and the main chain skeleton obtained by chain-growth polymerization may have at a terminal a linking group that bonds to another structure. The linking group need not be formed by step-growth polymerization or chain-growth polymerization.

The main chain skeleton obtained by step-growth polymerization in Component A is preferably a skeleton selected from the group consisting of a polyester skeleton, a polyurethane skeleton, a polyurethane urea skeleton, a polyamide skeleton, a polyalkylene glycol skeleton, and a polysiloxane skeleton, and more preferably a skeleton selected from the group consisting of a polyester skeleton, a polyurethane skeleton, a polyalkylene glycol skeleton, and a polysiloxane skeleton.

With regard to the main chain skeleton obtained by step-growth polymerization in Component A, one type may be present on its own or two or more types may be present.

A monomer that can be used in step-growth polymerization for forming Component A is not particularly limited, and a known step-growth polymerizable monomer may be used.

Preferred examples of the step-growth polymerizable monomer include a polycarboxylic acid compound, a polycarboxylic acid halide compound, a polyol compound, a polyamine compound, a polyisocyanate compound, a silane compound, a silanol compound, an acid anhydride compound, and a hydroxycarboxylic acid compound. The step-growth polymerizable monomer is preferably a difunctional monomer.

Specific examples of the step-growth polymerizable monomer include the compounds below, but the present invention is not limited thereby.

Examples of the polycarboxylic acid compound and polycarboxylic acid halide compound include maleic acid, maleic anhydride, fumaric acid, itaconic acid, phthalic acid, isophthalic acid, phthalic anhydride, terephthalic acid, 2,6-naphthalenedicarboxylic acid, 2,7-naphthalenedicarboxylic acid, 2,3-naphthalenedicarboxylic acid, 2,3-naphthalenedicarboxylic anhydride, 4,4′-biphenyldicarboxylic acid, tetrahydrophthalic anhydride, tetrahydrophthalic acid, hexahydrophthalic acid, hexahydrophthalic anhydride, hexahydroterephthalic acid, hexahydroisophthalic acid, succinic acid, adipic acid, sebacic acid, oxalic acid, malonic acid, glutaric acid, suberic acid, sodium 5-sulfoisophthalate, and compounds formed by changing a carboxyl group of the above polycarboxylic acid compounds into a carboxylic acid halide group.

Examples of the polyamine compound include an aliphatic polyamine such as hexanediamine, ethylenediamine, diethylenetriamine, triethylenetetramine, tetraethylenepentamine, m-xylenediamine, or p-xylenediamine, an alicyclic polyamine such as 1,3-diaminocyclohexane or isophoronediamine, a polyaniline such as 1,4-phenylenediamine, 2,3-diaminonaphthalene, 2,6-diaminoanthraquinone, 2,2-bis(4-aminophenyl)hexafluoropropane, 4,4′-diaminobenzophenone, or 4,4′-diaminodiphenylmethane, a Mannich base comprising a polycondensation product between a polyamine, an aldehyde compound, and a monohydric or polyhydric phenol, a polyamide polyamine formed from a reaction between a polyamine and a polycarboxylic acid or dimer acid, N,N′-dimethylethylenediamine, N,N′-diethylethylenediamine, N,N′-dibenzylethylenediamine, N,N′-diisopropylethylenediamine, 2,5-dimethylpiperazine, N,N′-dimethylcyclohexane-1,2-diamine, piperazine, homopiperazine, 2-methylpiperazine, and N,N-bis(3-aminophenyl)isophthalamide.

Examples of the polyol compound include ethylene glycol, diethylene glycol, propylene glycol, dipropylene glycol, trimethylene glycol, 1,4-tetramethylenediol, 1,3-tetramethylenediol, 2-methyl-1,3-trimethylenediol, 1,5-pentamethylenediol, neopentyl glycol, 1,6-hexamethylenediol, 1,7-heptanediol, 1,8-octanediol, 1,9-nonanediol, 1,10-decanediol, 3-methyl-1,5-pentamethylenediol, 2,4-diethyl-1,5-pentamethylenediol, glycerol, trimethylolpropane, trimethylolethane, hydroquinone, a cyclohexanediol (1,4-cyclohexanediol, etc.); a bisphenol (bisphenol A, bisphenol F, 4,4-diphenol, etc.), a sugar alcohol (xylitol, sorbitol, etc.); a polyalkylene glycol such as polyethylene glycol, polypropylene glycol, or polytetramethylene glycol; a novolac resin such as phenol novolac resin, cresol novolac resin, or a naphthol novolac resin; a polyfunctional phenolic resin such as a triphenolmethane-based resin; a modified phenolic resin such as a dicyclopentadiene-modified phenolic resin or a terpene-modified phenolic resin; an aralkyl type resin such as a phenylene skeleton-containing phenol aralkyl resin, a biphenylene skeleton-containing phenol aralkyl resin, a phenylene skeleton-containing naphthol aralkyl resin, or a biphenylene skeleton-containing naphthol aralkyl resin; and a sulfur atom-containing phenolic resin such as bisphenol S.

Examples of the polyisocyanate compound include m-phenylene diisocyanate, p-phenylene diisocyanate, 2,6-tolylene diisocyanate, 2,4-tolylene diisocyanate, naphthalene-1,4-diisocyanate, diphenylmethane-4,4′-diisocyanate, 3,3′-dimethoxybiphenyl diisocyanate, 3,3′-dimethyldiphenylmethane-4,4′-diisocyanate, xylylene-1,4-diisocyanate, xylylene-1,3-diisocyanate, 4-chloroxylylene-1,3-diisocyanate, 2-methylxylylene-1,3-diisocyanate, hydrogenated xylylene-1,4-diisocyanate, hydrogenated xylylene-1,3-diisocyanate, 4,4′-diphenylpropane diisocyanate, 4,4′-diphenylhexafluoropropane diisocyanate, trimethylene diisocyanate, hexamethylene diisocyanate, propylene-1,2-diisocyanate, butylene-1,2-diisocyanate, cyclohexylene-1,2-diisocyanate, cyclohexylene-1,3-diisocyanate, cyclohexylene-1,4-diisocyanate, dicyclohexylmethane-4,4′-diisocyanate, 1,4-bis(isocyanatomethyl)cyclohexane, 1,3-bis(isocyanatomethyl)cyclohexane, isophorone diisocyanate, diisocyanatomethylnorbornane, and lysine diisocyanate.

Examples of the silane compound include methyltrimethoxysilane, methyltriethoxysilane, phenyltrimethoxysilane, phenyltriethoxysilane, dimethyldimethoxysilane, dimethyldiethoxysilane, diphenyldimethoxysilane, diphenyldiethoxysilane, tetramethoxysilane, and tetraethoxysilane. Examples of the silanol compound include partial hydrolysis products of the above silane compounds.

Examples of the acid anhydride compound include succinic anhydride, maleic anhydride, phthalic anhydride, hexahydrophthalic anhydride, methylhexahydrophthalic anhydride, acid anhydride, hydrogenated acid anhydride, trimellitic anhydride, and pyromellitic anhydride.

Examples of the hydroxycarboxylic acid compound include hydroxyoctanoic acid, hydroxynonanoic acid, hydroxydecanoic acid, hydroxyundecanoic acid, hydroxydodecanoic acid, hydroxytetradecanoic acid, hydroxytridecanoic acid, hydroxyhexadecanoic acid, hydroxypentadecanoic acid, and hydroxystearic acid.

The main chain skeleton obtained by chain-growth polymerization in Component A is preferably a skeleton selected from the group consisting of an acrylic resin skeleton, a polystyrene skeleton, and a styrene-acrylic copolymer skeleton, and more preferably a skeleton selected from the group consisting of an acrylic resin skeleton and a styrene-acrylic copolymer skeleton.

Furthermore, the main chain skeleton obtained by chain-growth polymerization is preferably a skeleton obtained by chain-growth polymerization of an ethylenically unsaturated compound selected from the group consisting of an acrylic acid ester, a methacrylic acid ester, a styrene, and acrylonitrile, more preferably a skeleton obtained by chain-growth polymerization of an ethylenically unsaturated compound selected from the group consisting of an acrylic acid ester, a methacrylic acid ester, and a styrene, and particularly preferably a skeleton obtained by chain-growth polymerization of an ethylenically unsaturated compound selected from the group consisting of n-butyl acrylate and styrene.

Furthermore, with regard to the main chain skeleton obtained by chain-growth polymerization in Component A, one type may be present on its own or two or more types may be present.

A monomer used in chain-growth polymerization for forming Component A is not particularly limited, and a known chain-growth polymerizable monomer may be used.

The chain-growth polymerizable monomer is preferably a radically polymerizable monomer, and more preferably an ethylenically unsaturated compound.

Furthermore, the chain-growth polymerizable monomer is preferably a monofunctional radically polymerizable monomer, and particularly preferably a monofunctional ethylenically unsaturated compound.

Such a group of compounds is well known in the related industrial field, and they may be used without any particular limitation in the present invention.

The radically polymerizable monomer may be in any chemical form such as for example a monomer, a prepolymer, that is, a dimer, a trimer, or an oligomer, a copolymer thereof, and a mixture thereof.

With regard to the monomer that can be used in chain-growth polymerization for forming Component A, one type may be used on its own or two or more types may be used in combination.

Specific examples of the chain-growth polymerizable monomer include the compounds below, but the present invention is not limited thereby.

Examples of the chain-growth polymerizable monomer include a (meth)acrylic monomer.

Specific examples of the (meth)acrylic monomer include a straight chain or branched alkyl alcohol (meth)acrylate such as methyl(meth)acrylate, ethyl(meth)acrylate, n-butyl(meth)acrylate, i-butyl(meth)acrylate, t-butyl(meth)acrylate, hexyl(meth)acrylate, 2-ethylhexyl(meth)acrylate, or octyl(meth)acrylate; a cyclic alkyl alcohol (meth)acrylate such as cyclohexyl(meth)acrylate; a phosphoric acid group-containing (meth)acrylate such as 2-(meth)acryloyloxyethyl acid phosphate; a hydroxy group-containing (meth)acrylate such as 2-hydroxyethyl(meth)acrylate or 2-hydroxypropyl(meth)acrylate; a carbonyl group-containing (meth)acrylate such as acetoacetoxyethyl(meth)acrylate; and an amino group-containing (meth)acrylate such as N-dimethylaminoethyl(meth)acrylate or N-diethylaminoethyl(meth)acrylate.

Further examples of the chain-growth polymerizable monomer include a carboxyl group-containing monomer such as methacrylic acid, acrylic acid, itaconic acid, crotonic acid, maleic acid, fumaric acid, 2-succinoloyloxyethyl methacrylate, 2-maleinolyloxyethyl methacrylate, 2-phthaloyloxyethyl methacrylate, or 2-hexahydrophthaloyloxyethyl methacrylate; a sulfonic acid group-containing monomer such as allylsulfonic acid; a (meth)acrylonitrile such as acrylonitrile, methacrylonitrile, or α-chloroacrylonitrile; a vinyl carboxylate ester such as vinyl acetate or vinyl propionate; a vinyl halide such as vinyl fluoride, vinyl chloride, vinyl bromide, or vinyl iodide; a vinylidene halide such as vinylidene fluoride, vinylidene chloride, vinylidene bromide, or vinylidene iodide; and a conjugated diene compound such as butadiene, isoprene, chloroprene, or 1-chlorobutadiene.

Among them, n-butyl(meth)acrylate and/or styrene are particularly preferable.

Component A is a block copolymer and may comprise in the main chain a block obtained by step-growth polymerization and a block obtained by chain-growth polymerization. Furthermore, these blocks may be bonded directly to each other or bonded via a linking group or another block.

When Component A comprises two or more blocks formed from the same type of monomer unit, they may have identical or different molecular weights (weight-average molecular weight and number-average molecular weight), and the molecular structures thereof such as compositional proportions of monomer units, arrangement state, steric configuration, and crystal structure may be identical or different.

With regard to the monomer unit of each block in Component A, one type may be present on its own or two or more types may be present. For example, each block of Component A may be a homopolymer or a random copolymer.

Component A is preferably a straight-chain block copolymer.

The resin terminal of Component A is not particularly limited, and examples thereof include a hydrogen atom, an alkyl group, and a hydroxy group.

Component A is preferably a block copolymer obtained by chain-growth polymerization of a chain-growth polymerizable monomer using a macroinitiator having a main chain skeleton obtained by step-growth polymerization.

As the macroinitiator having a main chain skeleton obtained by step-growth polymerization, from the viewpoint of synthetic yield and solvent ink resistance, for example, a compound having a constituent unit represented by Formulae I to V below is preferable, a compound having a constituent unit represented by Formula I, Formula II, Formula IV, or Formula V is more preferable, and from the viewpoint of ink laydown and printing durability, a compound having a constituent unit represented by Formula IV or Formula V is yet more preferable. The molecular terminal (not illustrated) of Formulae I to V is preferably a hydrogen atom, an alkyl group having 1 to 5 carbons, or a hydroxy group.

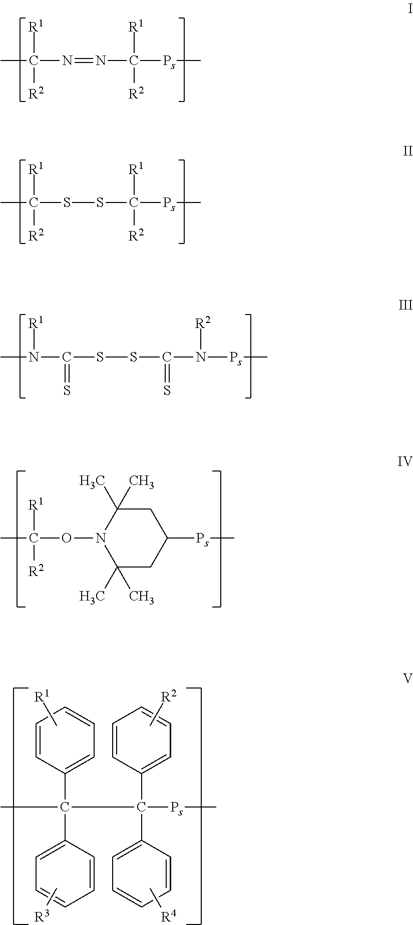

(In the Formulae, Ps denotes a main chain skeleton obtained by step-growth polymerization, and R¹ to R⁴ independently denote a hydrogen atom, a halogen atom, or a monovalent organic group.)

The main chain skeleton obtained by step-growth polymerization denoted by Ps has the same meaning as the main chain skeleton obtained by step-growth polymerization described above, and preferred embodiments are also the same.

Examples of the monovalent organic group denoted by R¹ to R⁴ include an alkyl group, an aryl group, a heterocyclic group, a heteroaromatic group, an alkoxy group, an aryloxy group, an alkylthio group, an arylthio group, an amino group, a hydroxy group, a cyano group, an alkoxycarbonyl group, an aryloxycarbonyl group, a carboxyl group, an acyl group, and an amide group. Furthermore, the monovalent organic group may be further substituted with a substituent. Examples of the substituent include a halogen atom and a group cited for the monovalent organic group.

With regard to R¹ to R⁴, two or more thereof may be bonded to each other, or any one or two or more of R¹ to R⁴ and another structure may be bonded.

Furthermore, the monovalent organic group denoted by R¹ to R⁴ preferably has 1 to 60 carbons, more preferably 1 to 30, and yet more preferably 1 to 20.

Specific preferred examples of the compound having a constituent unit represented by Formula I include a compound having a constituent unit represented by Formula I-1 or Formula I-2 below, and more preferred examples include a compound having a constituent repeating unit represented by Formula I-1 or Formula I-2 below.

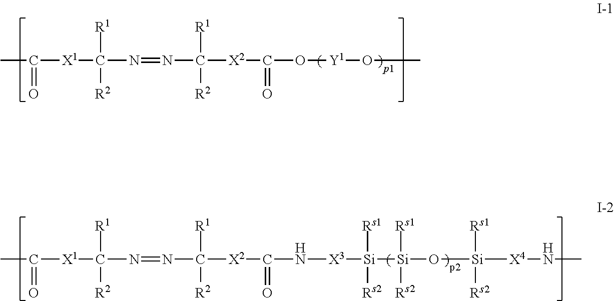

(In the Formulae, R¹ and R² independently denote an alkyl group having 1 to 6 carbons or a cyano group, R^{s1} and R^{s2} independently denote an alkyl group having 1 to 6 carbons or an aryl group, X¹ to X⁴ and Y¹ independently denote an alkylene group having 1 to 10 carbons, and p1 and p2 independently denote a positive integer.)

The alkyl group having 1 to 6 carbons denoted by R¹, R², R^{s1}, and R^{s2} in Formula I-1 and Formula I-2 above may be straight-chain or branched. Specific examples include a methyl group, an ethyl group, an n-propyl group, an isopropyl group, an n-butyl group, an isobutyl group, a tert-butyl group, a sec-butyl group, an n-pentyl group, an isopentyl group, a tert-pentyl group, a neopentyl group, an n-hexyl group, an isohexyl group, a 1-methylpentyl group, and a 2-methylpentyl group.

Examples of the aryl group denoted by R^{s1} and R^{s2} in Formula I-1 and Formula I-2 above include a phenyl group, an o-tolyl group, an m-tolyl group, a p-tolyl group, a 2,3-xylyl group, a 2,4-xylyl group, a 2,5-xylyl group, a 2,6-xylyl group, a 3,5-xylyl group, and a naphthyl group.

The alkylene group having 1 to 10 carbons denoted by X¹ to X⁴ and Y¹ in Formula I-1 and Formula I-2 above may be straight-chain, branched, or cyclic. Specific examples include a methylene group, an ethylene group, a propylene group, a butylene group, a 2-methylpropylene group, a pentylene group, a 2,2-dimethylpropylene group, a 2-ethylpropylene group, a hexylene group, a heptylene group, an octylene group, a 2-ethylhexylene group, a nonylene group, a decylene group, a cyclopropylene group, a cyclopentylene group, and a cyclohexylene group. Among them, X¹ to X⁴ are preferably an alkylene group having 1 to 6 carbons, and Y¹ is preferably an alkylene group having 2 to 4 carbons.

p1 and p2 in Formula I-1 and Formula I-2 above are preferably independently an integer of 1 to 200, and more preferably an integer of 1 to 100.

It is particularly preferable in Formula I-1 and Formula I-2 above that R¹ is a methyl group and R² is a cyano group.

As the compound represented by Formula I-2, a commercial product may be used, and examples include the macro azo initiator VSP series from Wako Pure Chemical Industries, Ltd., and specifically VPS-1001 (which has a polydimethylsiloxane unit, the molecular weight of this unit being about 10,000).

A compound represented by Formula I-2 is preferred to a compound represented by Formula I-1 since a relief layer that is formed has suppressed ink swelling. This is because in Formula I-2, Ps is a polysiloxane skeleton, which has high hydrophobicity, and a hydrophobic block is introduced into Component A.

The compound having a constituent unit represented by Formula II above is preferably a compound in which a disulfide structure is formed from a disulfide compound-derived structure having two hydroxy groups, and more preferably a polyurethane resin obtained by polycondensation of a disulfide compound having two hydroxy groups, a diol compound other than the disulfide compound, and a diisocyanate compound, or a polyester resin obtained by polycondensation of a disulfide compound having two hydroxy groups, a diol compound other than the disulfide compound, and a dicarboxylic acid compound, dicarboxylic acid halide compound and/or acid anhydride compound.

Ps in Formula II above is preferably a polyester skeleton, a polyurethane skeleton, or a polysiloxane skeleton.

Preferred examples of the disulfide compound having two hydroxy groups include the compounds below.

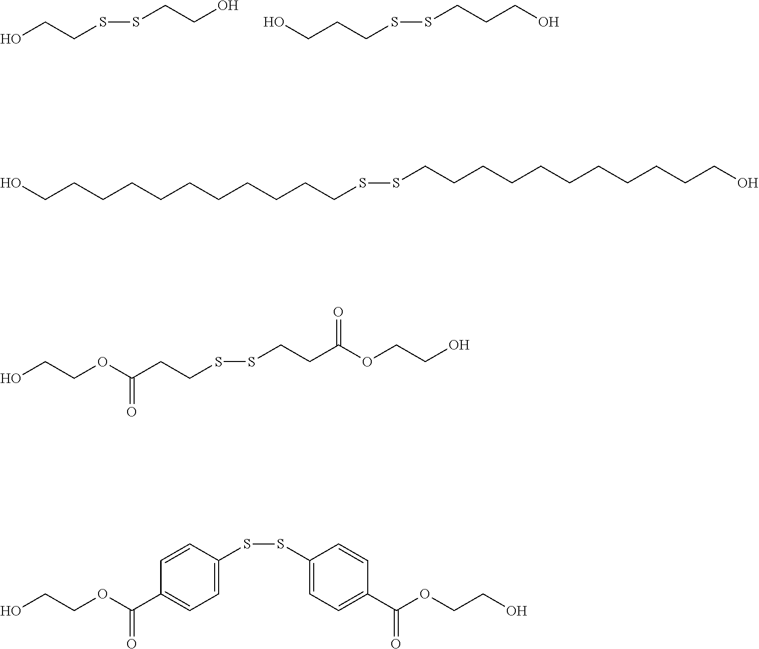 [SMILES: OCCSSCCO ; OCCCSSCCCO ; OCCCCCCCCCCCSSCCCCCCCCCCCO ; O=C(CCSSCCC(=O)OCCO)OCCO ; O=C(OCCO)c1ccc(SSc2ccc(C(=O)OCCO)cc2)cc1]

The compound having a constituent unit represented by Formula III above is preferably a compound in which a structure represented by Formula III-1 below is formed from a structure derived from a compound having two amino groups and a structure represented by Formula III-1 below, and more preferably a polyamide resin obtained by polycondensation of a compound having two amino groups and a structure represented by Formula III-1 below, a diamino compound other than the compound above, and a dicarboxylic acid compound, dicarboxylic acid halide compound and/or acid anhydride compound.

Ps in Formula III above is preferably a polyester skeleton, a polyurethane skeleton, or a polysiloxane skeleton.

Preferred examples of the compound having two amino groups and a structure represented by Formula III-1 below include a compound represented by Formula III-2.

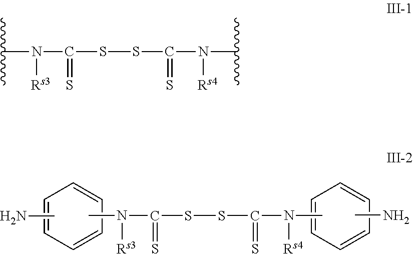

(In the Formulae, R^{s3} and R^{s4} independently denote a hydrogen atom, an alkyl group, an aryl group, a haloalkyl group, a cyanoalkyl group, or an alkoxyalkyl group, and a wavy line portion denotes the position of bonding to another structure.)

From the viewpoint of synthetic yield, the compound having a constituent unit represented by Formula IV above is preferably a compound having a constituent unit represented by Formula IV-1 or Formula IV-2 below, more preferably a compound having a constituent unit represented by Formula IV-1 or Formula IV-2 below in which Ps is a polyester skeleton, a polyurethane skeleton or a polysiloxane skeleton and, from the viewpoint of printing durability, yet more preferably a compound having a constituent unit represented by Formula IV-1 or Formula IV-2 below in which Ps is a polyurethane skeleton or a polysiloxane skeleton.

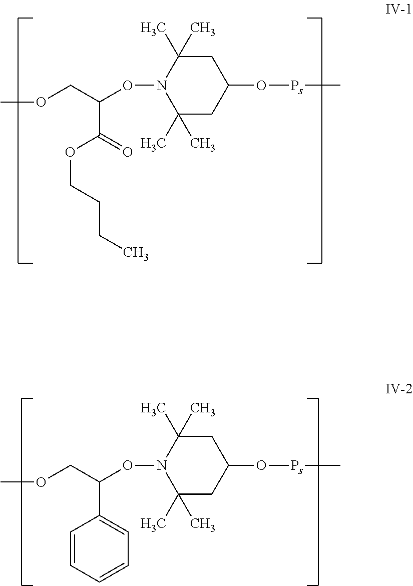

(In the Formulae, Ps denotes a main chain skeleton obtained by step-growth polymerization.)

The compound having a constituent unit represented by Formula V above is preferably a compound having a constituent unit represented by Formula V-1 or Formula V-2 below, and more preferably a compound having a constituent unit represented by Formula V-1 below. Furthermore, the compound having a constituent unit represented by Formula V above is preferably a compound having a constituent repeating unit represented by Formula V-1 or Formula V-2 below.

Furthermore, Ps in Formula V-1 below is preferably a polyurethane skeleton, a polyester skeleton, or a polysiloxane skeleton, and more preferably a polyurethane skeleton. Moreover, Ps in Formula V-2 below is preferably a polyurethane urea skeleton, a polyamide skeleton, or a polysiloxane skeleton.

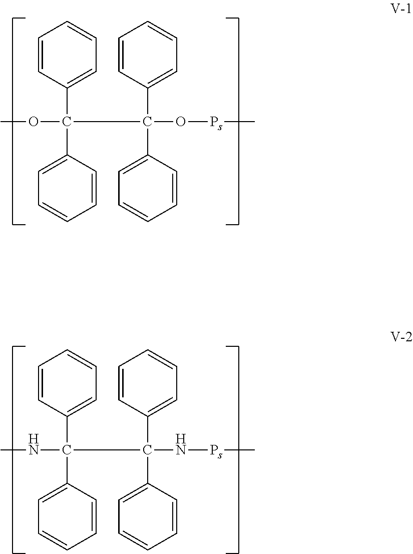

(In the Formulae, Ps denotes a main chain skeleton obtained by step-growth polymerization.)

Furthermore, from the viewpoint of synthetic yield and solvent ink resistance, Component A is preferably a block copolymer having a structure selected from the group consisting of structures represented by P-I to P-V and P′-I to P′-V below.

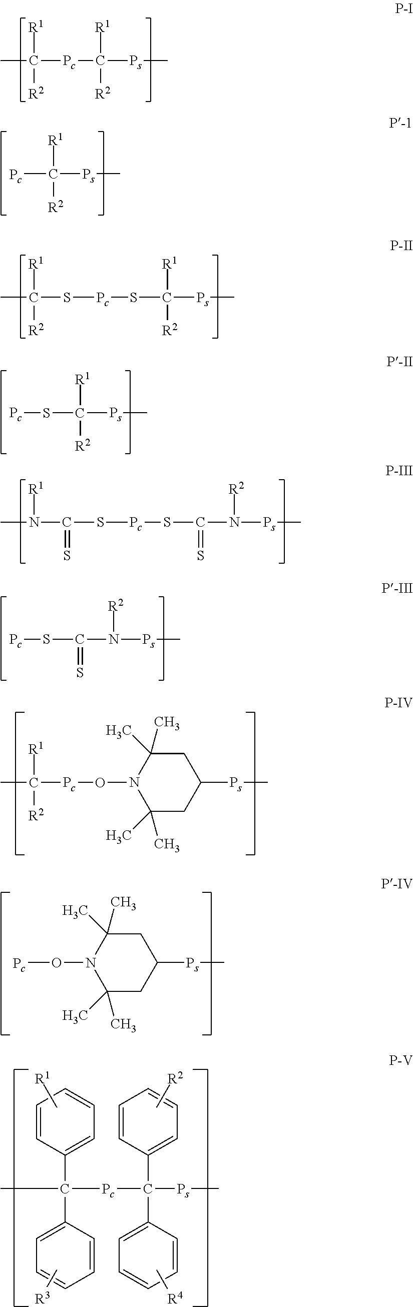

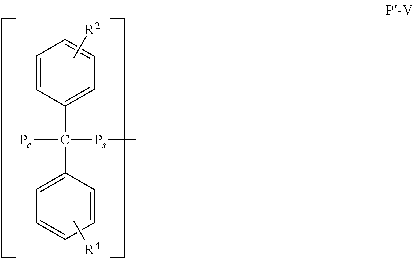

(In the Formulae, Ps denotes a main chain skeleton obtained by step-growth polymerization, Pc denotes a main chain skeleton obtained by chain-growth polymerization, and R¹ to R⁴ independently denote a hydrogen atom, a halogen atom, or a monovalent organic group.)

In the Formulae above, the main chain skeleton obtained by step-growth polymerization denoted by Ps has the same meaning as that of the main chain skeleton obtained by step-growth polymerization described above, and preferred embodiments are also the same.

In the Formulae above, the main chain skeleton obtained by chain-growth polymerization denoted by Pc has the same meaning as that of the main chain skeleton obtained by chain-growth polymerization described above, and preferred embodiments are also the same.

R¹ to R⁴ in the structures represented by P-I to P-V and P′-I to P′-V below have the same meanings as those of R¹ to R⁴ in the compound having a constituent unit represented by Formulae I to V above, and preferred embodiments are also the same.

Among them, from the viewpoint of synthetic yield and solvent ink resistance, Component A is preferably a block copolymer having a structure selected from the group consisting of structures represented by P-I, P-II, P-IV, P-V, P′-I, P′-II, P′-IV, and P′-V, from the viewpoint of ink laydown and printing durability more preferably a block copolymer having a structure selected from the group consisting of structures represented by P-IV, P-V, P′-IV, and P′-V, and particularly preferably a block copolymer having a structure represented by P-IV or P-V.

Furthermore, from the viewpoint of engraving sensitivity, swelling inhibition properties for aqueous ink and solvent ink, and printing durability, P-I to P-V and P′-I to P′-V above are preferably the embodiments below.

In the structure represented by P-I or P′-I, Ps is particularly preferably a polyalkylene glycol skeleton or a polysiloxane skeleton, and most preferably a polysiloxane skeleton.

In the structure represented by P-II or P′-II, Ps is particularly preferably a polyester skeleton, a polyurethane skeleton or a polysiloxane skeleton.

In the structure represented by P-III or P′-III, Ps is particularly preferably a polyurethane urea skeleton or a polysiloxane skeleton.

In the structure represented by P-IV or P′-IV, Ps is particularly preferably a polyester skeleton, a polyurethane skeleton or a polysiloxane skeleton, and most preferably a polyurethane skeleton or a polysiloxane skeleton.

In the structure represented by P-V or P′-V, Ps is particularly preferably a polyurethane skeleton or a polysiloxane skeleton.

Furthermore, in P-I to P-V and P′-I to P′-V, when Ps is a polyurethane skeleton, from the viewpoint of solvent ink printing durability, a polyurethane skeleton having a polysilicone chain is preferable, and a polyurethane skeleton formed by copolymerization of a both termini carbinol-modified silicone oil is more preferable.

The structure represented by P-I is preferably a structure represented by P-I-1 or P-I-2 below, and the structure represented by P′-I is preferably a structure represented by P′-I-1 or P′-I-2 below. Component A is more preferably a block copolymer having a structure selected from the group consisting of structures represented by P-I-1, P-I-2, P′-I-1, or P′-I-2 below.

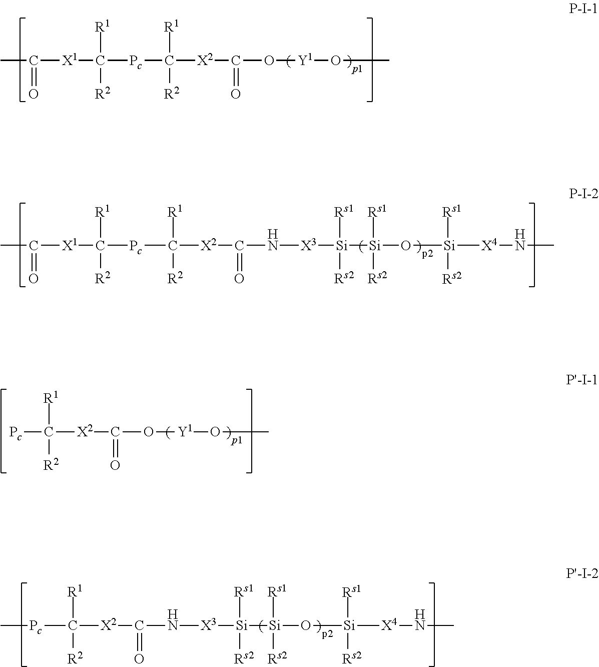

(In the Formulae, Pc denotes a main chain skeleton obtained by chain-growth polymerization, R¹ and R² independently denote an alkyl group having 1 to 6 carbons or a cyano group, R^{s1} and R^{s2} independently denote an alkyl group having 1 to 6 carbons or an aryl group, X¹ to X⁴ and Y¹ independently denote an alkylene group having 1 to 10 carbons, and p1 and p2 independently denote a positive integer.)

R¹, R², R^{s1}, R^{s2}, X¹ to X⁴, Y¹, p1, and p2 in P-I-1, P-I-2, P′-I-1, and P′-I-2 have the same meanings as those of R¹, R², R^{s1}, R^{s2}, X¹ to X⁴, Y¹, p1, and p2 in Formula I-1 and Formula I-2 above, and preferred embodiments are also the same.

The main chain skeleton obtained by chain-growth polymerization denoted by Pc in P-I-1, P-I-2, P′-I-1, and P′-I-2 has the same meaning as that of the main chain skeleton obtained by chain-growth polymerization described above, and preferred embodiments are also the same.

The structure represented by P-II above is preferably a structure represented by P-II-1 below, and the structure represented by P′-II above is preferably a structure represented by P′-II-1 below. Component A is more preferably a block copolymer having a structure selected from the group consisting of structures represented by P-II-1 or P′-II-1 below.

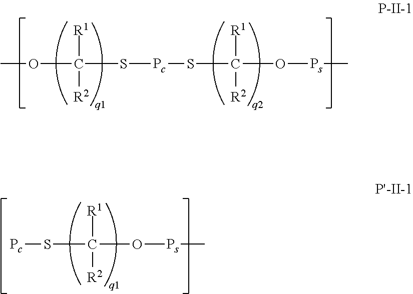

(In the Formulae, Ps denotes a main chain skeleton obtained by step-growth polymerization, Pc denotes a main chain skeleton obtained by chain-growth polymerization, R¹ and R² independently denote a hydrogen atom, a halogen atom, or a monovalent organic group, and the q1s independently denote an integer of one or greater.)

The main chain skeleton obtained by step-growth polymerization denoted by Ps in P-II-1 or P′-II-1 has the same meaning as that of the main chain skeleton obtained by step-growth polymerization described above, and preferred embodiments are also the same.

Furthermore, Ps in P-II-1 or P′-II-1 is particularly preferably a polyester skeleton, a polyurethane skeleton, or a polysiloxane skeleton, and most preferably a polyurethane skeleton or a polysiloxane skeleton.

The main chain skeleton obtained by chain-growth polymerization denoted by Pc in P-II-1 or P′-II-1 has the same meaning as that of the main chain skeleton obtained by chain-growth polymerization described above, and preferred embodiments are also the same.

R¹ and R² in the structure represented by P-II-1 or P′-II-1 have the same meanings as those of R¹ and R² in the compound having a constituent unit represented by Formula II above, and preferred embodiments are also the same.

q1 in P-II-1 or P′-II-1 is preferably an integer of 1 to 20, and more preferably an integer of 1 to 8.

The structure represented by P-III is preferably a structure represented by P-III-1 below, and the structure represented by P′-III above is preferably a structure represented by P′-III-1 below. Component A is more preferably a block copolymer having a structure selected from the group consisting of structures represented by P-III-1 or P′-III-1 below.

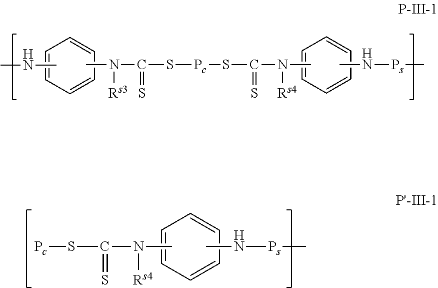

(In the Formulae, Ps denotes a main chain skeleton obtained by step-growth polymerization, Pc denotes a main chain skeleton obtained by chain-growth polymerization, and R^{s3} and R^{s4} independently denote a hydrogen atom, an alkyl group, an aryl group, a haloalkyl group, a cyanoalkyl group, or an alkoxyalkyl group.)

In P-III-1 or P′-III-1, the main chain skeleton obtained by step-growth polymerization denoted by Ps has the same meaning as that of the main chain skeleton obtained by step-growth polymerization described above, and preferred embodiments are also the same.

Furthermore, Ps in P-III-1 or P′-III-1 is particularly preferably a polyamide skeleton or a polysiloxane skeleton.

The main chain skeleton obtained by chain-growth polymerization denoted by Pc in P-III-1 or P′-III-1 has the same meaning as that of the main chain skeleton obtained by chain-growth polymerization described above, and preferred embodiments are also the same.

R^{s3} and R^{s4} in the structure represented by P-III-1 or P′-III-1 have the same meanings as those of R^{s3} and R^{s4} in the structure represented by Formula III-1 and the compound represented by Formula III-2 above, and preferred embodiments are also the same.

The structure represented by P-IV or P′-IV above is preferably a structure represented by P-IV-1 or P-IV-2 below. Component A is more preferably a block copolymer having a structure selected from the group consisting of structures represented by P-IV-1 or P-IV-2 below.

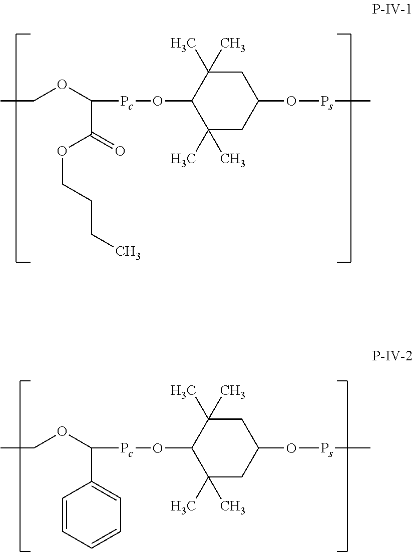

(In the Formulae, Ps denotes a main chain skeleton obtained by step-growth polymerization, and Pc denotes a main chain skeleton obtained by chain-growth polymerization.)

In P-IV-1 or P-IV-2, the main chain skeleton obtained by step-growth polymerization denoted by Ps has the same meaning as that of the main chain skeleton obtained by step-growth polymerization described above, and preferred embodiments are also the same.

Furthermore, Ps in P-IV-1 or P-IV-2 is particularly preferably a polyester skeleton, a polyurethane skeleton or a polysiloxane skeleton, and most preferably a polyurethane skeleton or a polysiloxane skeleton.

In P-IV-1 or P-IV-2, the main chain skeleton obtained by chain-growth polymerization denoted by Pc has the same meaning as that of the main chain skeleton obtained by chain-growth polymerization described above, and preferred embodiments are also the same.

Furthermore, Pc in P-IV-1 or P-IV-2 is particularly preferably a skeleton obtained by chain-growth polymerization of n-butyl acrylate and/or styrene, and is most preferably a poly(n-butyl acrylate) chain.

The structure represented by P-V above is preferably a structure represented by P-V-1 or P-V-2 below, and more preferably a structure represented by P-V-1 below. Furthermore, the structure represented by P′-V above is preferably a structure represented by P′-V-1 or P′-V-2 below, and more preferably a structure represented by P′-V-1 below. Component A is more preferably a block copolymer having a structure selected from the group consisting of structures represented by P-V-1, P-V-2, P′-V-1, or P′-V-2 below, yet more preferably a block copolymer having a structure selected from the group consisting of structures represented by P-V-1 or P′-V-1 below.

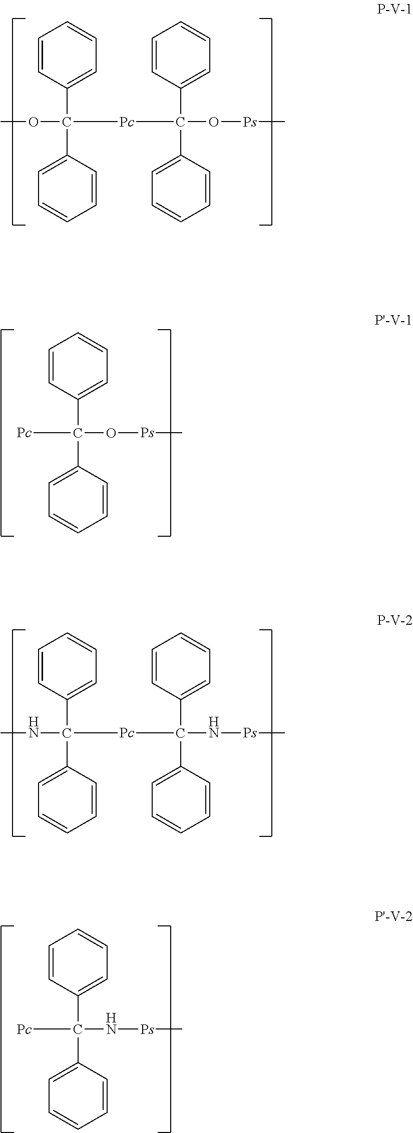

(In the Formulae, Ps denotes a main chain skeleton obtained by step-growth polymerization, and Pc denotes a main chain skeleton obtained by chain-growth polymerization.)

In P-V-1, P-V-2, P′-V-1, or P′-V-2, the main chain skeleton obtained by step-growth polymerization denoted by Ps has the same meaning as that of the main chain skeleton obtained by step-growth polymerization described above, and preferred embodiments are also the same.

Furthermore, Ps in P-V-1 or P-V-2 is particularly preferably a polyester skeleton, a polyurethane skeleton, or a polysiloxane skeleton, and most preferably a polyurethane skeleton or a polysiloxane skeleton. Ps in P′-V-1 or P′-V-2 is particularly preferably a polyurethane urea skeleton, a polyamide skeleton, or a polysiloxane skeleton.

In P-V-1, P-V-2, P′-V-1, or P′-V-2, the main chain skeleton obtained by chain-growth polymerization denoted by Pc has the same meaning as that of the main chain skeleton obtained by chain-growth polymerization described above, and preferred embodiments are also the same.

The weight-average molecular weight Mw of Component A is preferably 5,000 to 500,000, more preferably 8,000 to 300,000, yet more preferably 10,000 to 200,000, and particularly preferably 50,000 to 200,000. The weight-average molecular weight Mw and number-average molecular weight Mn in the present specification are measured using GPC (gel permeation chromatography).

Furthermore, with regard to Component A, one type may be present in the resin composition on its own or two or more types may be present.

The content of Component A in the resin composition is preferably 5 to 90 mass % relative to the total solids content, more preferably 15 to 85 mass %, and yet more preferably 30 to 80 mass %. It is preferable for the content of Component A to be in the above-mentioned range since the rinsing properties for engraving residue are excellent and a relief layer having excellent ink transfer properties is obtained. The solids content of the resin composition referred to here means the amount excluding volatile components such as solvent.

The resin composition for laser engraving of the present invention may comprise a binder polymer (resin component) other than Component A. The examples of the binder polymer other than Component A include the non-elastomers described in JP-A-2011-136455, and the unsaturated group-containing polymers described in JP-A-2010-208326.

The resin composition for laser engraving of the present invention preferably comprises Component A as a main component of the binder polymers, and if the resin composition comprises other binder polymers, the content of Component A relative to the total mass of the binder polymers is preferably 60 mass % or greater, more preferably 70 mass % or greater, and even more preferably 80 mass % or greater. Meanwhile, the upper limit of the content of Component A is not particularly limited, if the resin composition comprises other binder polymers, the upper limit thereof is preferably 99 mass % or less, more preferably 97 mass % or less, and yet more preferably 95 mass % or less.

### (Component B) Polymerizable Compound

The resin composition for laser engraving of the present invention comprises (Component B) a polymerizable compound.

‘Polymerization’ in the present invention includes not only polymerization in the narrow term but also polycondensation or polyaddition.

The polymerizable compound that can be used in the present invention is not particularly limited as long as it is polymerizable, and a known compound may be used. Specific preferred examples include an ethylenically unsaturated compound, a silane compound, a polycarboxylic acid compound, a polycarboxylic acid halide compound, a polyol compound, a polyamine compound, a polyisocyanate compound, an acid anhydride compound, and a hydroxycarboxylic acid compound.

The silane compound in Component B is preferably a compound comprising at least one type from a hydrolyzable silyl group and a silanol group, which are described later.

Furthermore, the ethylenically unsaturated compound in Component B is preferably a polyfunctional ethylenically unsaturated compound.

Among them, Component B is preferably an ethylenically unsaturated compound and/or a compound comprising at least one type from a hydrolyzable silyl group and a silanol group, more preferably an ethylenically unsaturated compound and a compound comprising at least one type from a hydrolyzable silyl group and a silanol group, and yet more preferably a (meth)acrylate derivative and a compound comprising at least one type from a hydrolyzable silyl group and a silanol group. When in this mode, a flexographic printing plate having excellent printing durability and swelling inhibition properties for aqueous ink and solvent ink can be obtained.

Examples of the ethylenically unsaturated compound, silane compound, polycarboxylic acid compound, polycarboxylic acid halide compound, polyol compound, polyamine compound, polyisocyanate compound, acid anhydride compound, and hydroxycarboxylic acid compound that can be used in Component B include the step-growth polymerizable monomers and chain-growth polymerizable monomers described for Component A.

Among them, as the ethylenically unsaturated compound and the silane compound, the compounds below are preferable.

Furthermore, the polymerizable compound that can be used in the present invention preferably has a molecular weight (or weight average molecular weight) of less than 5,000.

The ethylenically unsaturated compound is a compound having one or more ethylenically unsaturated groups. Regarding the ethylenically unsaturated compound, one kind may be used alone, or two or more kinds may be used in combination.

Furthermore, the compound group which belongs to ethylenically unsaturated compounds is widely known in the pertinent industrial fields, and in the present invention, these compounds can be used without particular limitations. These compounds have chemical forms such as, for example, monomer, prepolymer (namely, dimer, trimer and oligomer), or copolymer thereof, and mixture thereof.

As the ethylenically unsaturated compound, a polyfunctional monomer is preferably used. Molecular weights of these polyfunctional monomers are preferably 200 to 2,000.

As the polyfunctional ethylenically unsaturated compound, a compound having 2 to 20 terminal ethylenically unsaturated groups is preferable.

Examples of a compound from which the ethylenically unsaturated group in the polyfunctional ethylenically unsaturated compound is derived include unsaturated carboxylic acids (such as acrylic acid, methacrylic acid, itaconic acid, crotonic acid, isocrotonic acid and maleic acid), and esters and amides thereof. Preferably esters of an unsaturated carboxylic acid and an aliphatic polyhydric alcoholic compound, or amides of an unsaturated carboxylic acid and an aliphatic polyvalent amine compound are used. Moreover, addition reaction products of unsaturated carboxylic acid esters or amides having a nucleophilic substituent such as a hydroxyl group or an amino group with polyfunctional isocyanates or epoxies, and dehydrating condensation reaction products with a polyfunctional carboxylic acid, etc. are also used favorably. Moreover, addition reaction products of unsaturated carboxylic acid esters or amides having an electrophilic substituent such as an isocyanato group or an epoxy group with monofunctional or polyfunctional alcohols or amines, and substitution reaction products of unsaturated carboxylic acid esters or amides having a leaving group such as a halogen group or a tosyloxy group with monofunctional or polyfunctional alcohols or amines are also favorable. Moreover, as another example, the use of compounds obtained by replacing the unsaturated carboxylic acid with a vinyl compound, an allyl compound, an unsaturated phosphonic acid, styrene or the like is also possible.

The ethylenically unsaturated group which is comprised in the polyfunctional ethylenically unsaturated compound described above is preferably an residue of an acrylate compound, a methacrylate compound, a vinyl compound, or an aryl compound, and particularly preferably an acrylate compound or a methacrylate compound, from the viewpoint of reactivity. From the viewpoint of printing durability, the polyfunctional ethylenically unsaturated compound more preferably has three or more ethylenically unsaturated groups.

Specific examples of ester monomers comprising an ester of an aliphatic polyhydric alcohol compound and an unsaturated carboxylic acid include acrylic acid esters such as ethylene glycol diacrylate, triethylene glycol diacrylate, polyethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, and a polyester acrylate oligomer.

Examples of methacrylic acid esters include tetramethylene glycol dimethacrylate, triethylene glycol dimethacrylate, polyethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(methacryloxyethoxy)phenyl]dimethylmethane. Among them, trimethylolpropane trimethacrylate and polyethylene glycol dimethacrylate are particularly preferable.

As examples of other esters, aliphatic alcohol-based esters described in JP-B-46-27926 (JP-B denotes a Japanese examined patent application publication), JP-B-51-47334 and JP-A-57-196231, those having an aromatic skeleton described in JP-A-59-5240, JP-A-59-5241, and JP-A-2-226149, those having an amino group described in JP-A-1-165613, etc. may also be used preferably.

The above-mentioned ester monomers may be used as a mixture.

Furthermore, specific examples of amide monomers including an amide of an aliphatic polyamine compound and an unsaturated carboxylic acid include methylenebisacrylamide, methylenebismethacrylamide, 1,6-hexamethylenebisacrylamide, 1,6-hexamethylenebismethacrylamide, diethylenetriaminetrisacrylamide, xylylenebisacrylamide, and xylylenebismethacrylamide.

Preferred examples of other amide-based monomers include those having a cyclohexylene structure described in JP-B-54-21726.

Furthermore, a urethane-based addition-polymerizable compound produced by an addition reaction of an isocyanate and a hydroxy group is also suitable, and specific examples thereof include a vinylurethane compound comprising two or more polymerizable vinyl groups per molecule in which a hydroxy group-containing vinyl monomer represented by Formula (i) below is added to a polyisocyanate compound having two or more isocyanate groups per molecule described in JP-B-48-41708.

CH₂═C(R)COOCH₂CH(R′)OH (i)

wherein R and R′ independently denote H or CH₃.

Furthermore, urethane acrylates described in JP-A-51-37193, JP-B-2-32293, and JP-B-2-16765, and urethane compounds having an ethylene oxide-based skeleton described in JP-B-58-49860, JP-B-56-17654, JP-B-62-39417, JP-B-62-39418 are also suitable.

Furthermore, by use of an addition-polymerizable compound having an amino structure in the molecule described in JP-A-63-277653, JP-A-63-260909, and JP-A-1-105238, a resin composition having very good curing speed can be obtained.

Other examples include polyester acrylates such as those described in JP-A-48-64183, JP-B-49-43191, and JP-B-52-30490, and polyfunctional acrylates and methacrylates such as epoxy acrylates formed by a reaction of an epoxy resin and (meth)acrylic acid. Examples also include specific unsaturated compounds described in JP-B-46-43946, JP-B-1-40337, and JP-B-1-40336, and vinylphosphonic acid-based compounds described in JP-A-2-25493. In some cases, perfluoroalkyl group-containing structures described in JP-A-61-22048 are suitably used. Moreover, those described as photocuring monomers or oligomers in the Journal of the Adhesion Society of Japan, Vol. 20, No. 7, pp. 300 to 308 (1984) may also be used.

Among them, the polyfunctional ethylenically unsaturated compound preferably comprises a (meth)acrylate derivative, more preferably an alkylenediol di(meth)acrylate, yet more preferably an alkylenediol di(meth)acrylate in which the alkylenediol has 4 to 12 carbons, and particularly preferably 1,6-hexanediol di(meth)acrylate. When in this mode, a flexographic printing plate having excellent printing durability and swelling inhibition properties for aqueous ink and solvent ink can be obtained.

Furthermore, Component B preferably comprises a compound comprising at least one type from a hydrolyzable silyl group and a silanol group, and more preferably an ethylenically unsaturated compound and a compound comprising at least one type from a hydrolyzable silyl group and a silanol group. When in this mode, a flexographic printing plate having excellent rinsing properties for engraving residue and having excellent printing durability and swelling inhibition properties for aqueous ink and solvent ink can be obtained.

The ‘hydrolyzable silyl group’ in the compound comprising at least one type from a hydrolyzable silyl group and a silanol group is a silyl group that can be hydrolyzed; examples of the hydrolyzable group include an alkoxy group, a mercapto group, a halogen atom, an amide group, an acetoxy group, an amino group, and an isopropenoxy group. A silyl group undergoes hydrolysis to become a silanol group, and a silanol group undergoes dehydration-condensation to form a siloxane bond. Such a hydrolyzable silyl group or silanol group is preferably one represented by Formula (B-1) below.

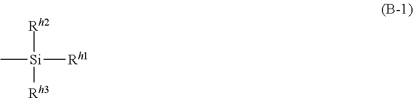

In Formula (B-1) above, at least one of R^{h1} to R^{h3} denotes a hydrolyzable group selected from the group consisting of an alkoxy group, a mercapto group, a halogen atom, an amide group, an acetoxy group, an amino group, and an isopropenoxy group, or a hydroxy group. The remainder of R^{h1} to R^{h3} independently denotes a hydrogen atom, a halogen atom, or a monovalent organic substituent (examples including an alkyl group, an aryl group, an alkenyl group, an alkynyl group, and an aralkyl group).

In Formula (B-1) above, the hydrolyzable group bonded to the silicon atom is particularly preferably an alkoxy group or a halogen atom, and more preferably an alkoxy group.

From the viewpoint of rinsing properties and printing durability, the alkoxy group is preferably an alkoxy group having 1 to 30 carbon atoms, more preferably an alkoxy group having 1 to 15 carbon atoms, yet more preferably an alkoxy group having 1 to 5 carbon atoms, particularly preferably an alkoxy group having 1 to 3 carbon atoms, and most preferably a methoxy group or an ethoxy group.

Furthermore, examples of the halogen atom include an F atom, a Cl atom, a Br atom, and an I atom, and from the viewpoint of ease of synthesis and stability it is preferably a Cl atom or a Br atom, and more preferably a Cl atom.

The compound comprising at least one type from a hydrolyzable silyl group and a silanol group in the present invention is preferably a compound having one or more groups represented by Formula (B-1) above, and more preferably a compound having two or more. A compound having two or more hydrolyzable silyl groups is particularly preferably used. That is, a compound having in the molecule two or more silicon atoms having a hydrolyzable group bonded thereto is preferably used. The number of silicon atoms having a hydrolyzable group bond thereto contained in Component E is preferably at least 2 but no greater than 6, and most preferably 2 or 3.

A range of 1 to 4 of the hydrolyzable groups may bond to one silicon atom, and the total number of hydrolyzable groups in Formula (B-1) is preferably in a range of 2 or 3. It is particularly preferable that three hydrolyzable groups are bonded to a silicon atom. When two or more hydrolyzable groups are bonded to a silicon atom, they may be identical to or different from each other.

Specific preferred examples of the alkoxy group include a methoxy group, an ethoxy group, a propoxy group, an isopropoxy group, a butoxy group, a tert-butoxy group, a phenoxy group, and a benzyloxy group. A plurality of each of these alkoxy groups may be used in combination, or a plurality of different alkoxy groups may be used in combination.

Examples of the alkoxysilyl group having an alkoxy group bonded thereto include a trialkoxysilyl group such as a trimethoxysilyl group, a triethoxysilyl group, a triisopropoxysilyl group, or a triphenoxysilyl group; a dialkoxymonoalkylsilyl group such as a dimethoxymethylsilyl group or a diethoxymethylsilyl group; and a monoalkoxydialkylsilyl group such as a methoxydimethylsilyl group or an ethoxydimethylsilyl group.

The compound comprising at least one type from a hydrolyzable silyl group and a silanol group preferably has at least a sulfur atom, an ester bond, a urethane bond, an ether bond, a urea bond, or an imino group.

Among them, from the viewpoint of crosslinkability, the compound comprising at least one type from a hydrolyzable silyl group and a silanol group preferably comprises a sulfur atom, and from the viewpoint of removability (rinsing properties) of engraving residue it is preferable for it to comprise an ester bond, a urethane bond, or an ether bond (in particular, an ether bond contained in an oxyalkylene group), which is easily decomposed by aqueous alkali. A compound comprising at least one type from a hydrolyzable silyl group and a silanol group containing a sulfur atom functions as a vulcanizing agent or a vulcanization accelerator when carrying out a vulcanization treatment, thus promoting a reaction (crosslinking) of a conjugated diene monomer unit-containing polymer. As a result, the rubber elasticity necessary as a printing plate is exhibited. Furthermore, the strength of a crosslinked relief-forming layer and a relief layer is improved.

Furthermore, the compound comprising at least one type from a hydrolyzable silyl group and a silanol group in the present invention is preferably a compound that does not have an ethylenically unsaturated bond.

As the compound comprising at least one type from a hydrolyzable silyl group and a silanol group in the present invention, there can be cited a compound in which a plurality of groups represented by Formula (B-1) above are bonded via a divalent linking group, and from the viewpoint of the effect, such a divalent linking group is preferably a linking group having a sulfide group (—S—), an imino group (—N(R)—) a urea group or a urethane bond (—OCON(R)— or —N(R)COO—). R denotes a hydrogen atom or a substituent. Examples of the substituent denoted by R include an alkyl group, an aryl group, an alkenyl group, an alkynyl group, and an aralkyl group.

A method for synthesizing the compound comprising at least one type from a hydrolyzable silyl group and a silanol group is not particularly limited, and synthesis can be carried out by a known method. Examples of the method include a method described in paragraphs 0019 to 0021 of JP-A-2011-136429.

The compound comprising at least one type from a hydrolyzable silyl group and a silanol group is preferably a compound represented by Formula (B-A-1) or Formula (B-A-2) below.

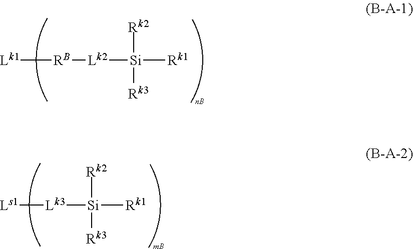

(In Formula (B-A-1) and Formula (B-A-2), R^{B} denotes an ester bond, an amide bond, a urethane bond, a urea bond, or an imino group, L^{k1} denotes an n-valent linking group, L^{k2} denotes a divalent linking group, L^{s1} denotes an co-valent linking group, L^{k3} denotes a divalent linking group, nB and mB independently denote an integer of 1 or greater, and R^{k1} to R^{k3} independently denote a hydrogen atom, a halogen atom, or a monovalent organic substituent. In addition, at least one of R^{k1} to R^{k3} denotes a hydrolyzable group selected from the group consisting of an alkoxy group, a mercapto group, a halogen atom, an amide group, an acetoxy group, an amino group, and an isopropenoxy group, or a hydroxy group.)

R^{k1} to R^{k3} in Formula (B-A-1) and Formula (B-A-2) above have the same meanings as those of R^{h1} to R^{h3} in Formula (B-1) above, and preferred ranges are also the same.

From the viewpoint of rinsing properties and film strength, R^{B} above is preferably an ester bond or a urethane bond, and is more preferably an ester bond.

The divalent or nB-valent linking group denoted by L^{k1} to L^{k3} above is preferably a group formed from at least one type of atom selected from the group consisting of a carbon atom, a hydrogen atom, an oxygen atom, a nitrogen atom, and a sulfur atom, and is more preferably a group formed from at least one type of atom selected from the group consisting of a carbon atom, a hydrogen atom, an oxygen atom, and a sulfur atom. The number of carbon atoms of L^{k1} to L^{k3} above is preferably 2 to 60, and more preferably 2 to 30.

The mB-valent linking group denoted by L^{s1} above is preferably a group formed from a sulfur atom and at least one type of atom selected from the group consisting of a carbon atom, a hydrogen atom, an oxygen atom, a nitrogen atom, and a sulfur atom, and is more preferably an alkylene group or a group formed by combining two or more from an alkylene group, a sulfide group, and an imino group. The number of carbon atoms of L^{s1} above is preferably 2 to 60, and more preferably 6 to 30.

nB and mB above are preferably and independently integers of 1 to 10, more preferably integers of 2 to 10, yet more preferably integers of 2 to 6, and particularly preferably 2.

From the viewpoint of removability (rinsing properties) of engraving residue, the nB-valent linking group denoted by L^{k1} and/or the divalent linking group denoted by L^{k2}, or the divalent linking group denoted by L^{k3} preferably has an ether bond, and more preferably has an ether bond contained in an oxyalkylene group.

Among compounds represented by Formula (B-A-1) or Formula (B-A-2), from the viewpoint of crosslinkability, etc., the nB-valent linking group denoted by L^{k1} and/or the divalent linking group denoted by L^{k2} in Formula (B-A-1) are preferably groups having a sulfur atom.

The compound comprising at least one type from a hydrolyzable silyl group and a silanol group is preferably a compound having at least an alkoxy group on the silicon atom of a silyl group, more preferably a compound having two alkoxy groups on the silicon atom of a silyl group, and yet more preferably a compound having three alkoxy group on the silicon atom of a silyl group.

Furthermore, specific examples of the compound comprising at least one type from a hydrolyzable silyl group and a silanol group include compounds described in paragraphs 0025 to 0037 of JP-A-2011-136429.

Among them, the compound comprising at least one type from a hydrolyzable silyl group and a silanol group is preferably a compound having a mercapto group or a sulfide bond, and particularly preferably a compound having a sulfide bond.

Furthermore, the total number of hydrolyzable silyl groups and silanol groups in the compound comprising at least one type from a hydrolyzable silyl group and a silanol group is preferably 1 to 6, more preferably 1 or 2, and particularly preferably 2.

The content of Component B in the resin composition for laser engraving is preferably 1 to 90 mass % relative to the total solids content, more preferably 10 to 80 mass %, yet more preferably 20 to 75 mass %, and particularly preferably 30 to 70 mass %. When in the above-mentioned range, a relief-forming layer comprising the resin composition for laser engraving has excellent printing durability.

### (Component C) Polymerization Initiator

The resin composition for laser engraving of the present invention comprises (Component C) a polymerization initiator.

Any polymerization initiator known to a person skilled in the art may be used without any restrictions. A radical polymerization initiator, which is a preferred polymerization initiator, is explained in detail below, but the present invention is not restricted by these descriptions.

Component C is preferably a radical polymerization initiator.

Furthermore, when a silane compound, in particular a compound comprising at least one type from a hydrolyzable silyl group and a silanol group, is contained as the polymerizable compound, it is preferable for Component C to comprise a silane coupling catalyst.

Furthermore, examples of the polymerization initiator include a photopolymerization initiator, a thermopolymerization initiator, a polycondensation catalyst, and a silane coupling catalyst, and it is preferable for it to comprise at least a thermopolymerization initiator.

In the present invention, preferable polymerization initiators include (a) aromatic ketones, (b) onium salt compounds, (c) organic peroxides, (d) thio compounds, (e) hexaallylbiimidazole compounds, (f) ketoxime ester compounds, (g) borate compounds, (h) azinium compounds, (i) metallocene compounds, (j) active ester compounds, (k) compounds having a carbon halogen bond, and (l) azo compounds. Hereinafter, although specific examples of the (a) to (l) are cited, the present invention is not limited to these.

In the present invention, when applies to the relief-forming layer of the flexographic printing plate precursor, from the viewpoint of engraving sensitivity and making a favorable relief edge shape, (c) organic peroxides and (l) azo compounds are more preferable, and (c) organic peroxides are particularly preferable.

The (a) aromatic ketones, (b) onium salt compounds, (d) thio compounds, (e) hexaallylbiimidazole compounds, (f) ketoxime ester compounds, (g) borate compounds, (h) azinium compounds, (i) metallocene compounds, (j) active ester compounds, and (k) compounds having a carbon halogen bonding may preferably include compounds described in paragraphs 0074 to 0118 of JP-A-2008-63554.

Moreover, (c) organic peroxides and (l) azo compounds preferably include the following compounds.

### (c) Organic Peroxide

Preferred examples of the organic peroxide (c) as a polymerization initiator that can be used in the present invention include peroxyester-based ones such as 3,3′,4,4′-tetra(t-butylperoxycarbonyl)benzophenone, 3,3′,4,4′-tetra(t-amylperoxycarbonyl)benzophenone, 3,3′,4,4′-tetra(t-hexylperoxycarbonyl)benzophenone, 3,3′,4,4′-tetra(t-octylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, t-butylperoxybenzoate, di-t-butyldiperoxyisophthalate, t-butylperoxy-3-methylbenzoate, t-butylperoxylaurate, t-butylperoxypivalate, t-butylperoxy-2-ethylhexanoate, t-butylperoxy-3,5,5-trimethylhexanoate, t-butylperoxyneoheptanoate, t-butylperoxyneodecanoate, and t-butylperoxyacetate, α,α′-di(t-butylperoxy)diisopropylbenzene, t-butylcumylperoxide, di-t-butylperoxide, t-butylperoxyisopropylmonocarbonate, and t-butylperoxy-2-ethylhexylmonocarbonate.

### (l) Azo Compounds

Preferable (l) azo compounds as a polymerization initiator that can be used in the present invention include those such as 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), dimethyl 2,2′-azobis(isobutyrate), 2,2′-azobis(2-methylpropionamideoxime), 2,2′-azobis[2-(2-imidazol in-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methyl-propionamide], 2,2′-azobis(2,4,4-trimethylpentane).

In the present invention, the organic peroxide (c) is particularly preferable as the polymerization initiator in the present invention from the viewpoint of crosslinking properties of the film (relief-forming layer) and improving the engraving sensitivity.

From the viewpoint of the engraving sensitivity, an embodiment obtained by combining (c) an organic peroxide, Component B and a photothermal conversion agent described below is particularly preferable.

This is presumed as follows. When the relief-forming layer is cured by thermal crosslinking using an organic peroxide, an organic peroxide that did not play a part in radical generation and has not reacted remains, and the remaining organic peroxide works as an autoreactive additive and decomposes exothermally in laser engraving. As the result, energy of generated heat is added to the irradiated laser energy to thus raise the engraving sensitivity.

It will be described in detail in the explanation of photothermal converting agent, the effect thereof is remarkable when carbon black is used as the photothermal converting agent. It is considered that the heat generated from the carbon black is also transmitted to (c) an organic peroxide and, as the result, heat is generated not only from the carbon black but also from the organic peroxide, and that the generation of heat energy to be used for the decomposition of Component A etc. occurs synergistically.

In the case of using a silane compound as Component B in the resin composition for laser engraving of the present invention, it is preferable to further comprise a silane coupling catalyst in order to accelerate the reaction with a silane compound.

As the silane coupling catalyst, any reaction catalyst that is generally used can be applied without limitation. The silane coupling catalyst may be used as a polycondensation catalyst.

Hereinafter, an acidic or a basic catalyst, and metal complex catalysts, which are representative silane coupling catalysts, will be described in sequence.

### —Acidic or Basic Catalyst—

As the silane coupling catalyst, an acidic or a basic compound is used as it is or in the form of a solution in which it is dissolved in a solvent such as water or an organic solvent (hereinafter, called an acidic catalyst or a basic catalyst). The concentration when dissolved in a solvent is not particularly limited, and it may be selected appropriately according to the properties of the acidic or basic compound used, desired catalyst content, etc.

The type of the acidic or basic catalyst is not limited, and examples of the acidic catalyst include halogenated hydrogen such as hydrochloric acid, nitric acid, sulfuric acid, sulfurous acid, hydrogen sulfide, perchloric acid, hydrogen peroxide, carbonic acid, carboxylic acids such as formic acid and acetic acid, substituted carboxylic acids in which R of a structural formula represented by RCOOH is substituted by another element or substituent, sulfonic acids such as benzenesulfonic acid, phosphoric acid, etc, and examples of the basic catalyst include an ammoniacal base such as aqueous ammonia, an amine such as ethyl amine and aniline etc. Among these, from the viewpoint of progressing fastly a condensation reaction of silane compounds in the layer, methanesulfonic acid, p-toluenesulfonic acid, pyridinium-p-toluene sulfonate, phosphoric acid, phosphonic acid, acetic acid, 1,8-diazabicyclo[5.4.0]undec-7-ene, and hexamethylenetetramine are preferable, methanesulfonic acid, p-toluenesulfonic acid, phosphoric acid, 1,8-diazabicyclo[5.4.0]undec-7-ene, and hexamethylenetetramineare are more preferable, and 1,8-diazabicyclo[5.4.0]undec-7-ene phosphoric acid and are particularly preferable.

### —Metal Complex Catalyst—

The metal complex catalyst that can be used as a silane coupling exchange reaction catalyst in the present invention is preferably constituted from a metal element selected from Groups 2, 4, 5, and 13 of the periodic table and an oxo or hydroxy oxygen compound selected from β-diketones (acetylacetone is preferable), ketoesters, hydroxycarboxylic acids and esters thereof, amino alcohols, and enolic active hydrogen compounds.

Furthermore, among the constituent metal elements, a Group 2 element such as Mg, Ca, Sr, or Ba, a Group 4 element such as Ti or Zr, a Group 5 element such as V, Nb, or Ta, and a Group 13 element such as Al or Ga are preferable, and they form a complex having an excellent catalytic effect. Among them, a complex obtained from Zr, Al, or Ti is excellent and preferable, and more preferred examples of the metal complex catalyst include ethyl orthotitanate, etc.

These metal complex catalysts are excellent in terms of stability in an aqueous coating solution and an effect in promoting gelling in a sol-gel reaction when thermally drying, and among them, ethyl acetoacetate aluminum diisopropylate, aluminum tris(ethyl acetoacetate), a di(acetylacetonato)titanium complex salt, and zirconium tris(ethyl acetoacetate) are particularly preferable.

Component C in the resin composition of the present invention may be used singly or in a combination of two or more compounds.

The content of Component C in the resin composition of the present invention is preferably 0.1 to 20 mass % relative to the total mass of the solids content, more preferably 0.3 to 10 mass %, and particularly preferably 0.5 to 5 mass %. It is preferable for the content of Component C to be in the above-mentioned range since rinsing properties and ink transfer properties are excellent.

### (Component D) Photothermal Conversion Agent

The resin composition for laser engraving of the present invention preferably further includes (Component D) a photothermal conversion agent. That is, it is considered that the photothermal conversion agent in the present invention can promote the thermal decomposition of a cured material during laser engraving by absorbing laser light and generating heat. Therefore, it is preferable that a photothermal conversion agent capable of absorbing light having a wavelength of laser used for graving be selected.

When a laser (a YAG laser, a semiconductor laser, a fiber laser, a surface emitting laser, etc.) emitting infrared at a wavelength of 700 to 1,300 nm is used as a light source for laser engraving, it is preferable for the flexographic printing plate precursor for laser engraving which is produced by using the resin composition for laser engraving of the present invention to comprise a photothermal conversion agent that has a maximum absorption wavelength at 700 to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific examples include dyes having a maximum absorption wavelength at 700 to 1,300 nm, and preferable examples include azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes. In particular, cyanine-based colorants such as heptamethine cyanine colorants, oxonol-based colorants such as pentamethine oxonol colorants, and phthalocyanine-based colorants are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saishin Ganryo Ouyogijutsu’ (Latest Applications of Pigment Technology) (CMC Publishing, 1986), ‘Insatsu Inki Gijutsu’ (Printing Ink Technology) (CMC Publishing, 1984). Examples of pigments include pigments described in paragraphs 0122 to 0125 of JP-A-2009-178869.

Among these pigments, carbon black is preferable.

Any carbon black, regardless of classification by ASTM (American Society for Testing and Materials) and application (e.g. for coloring, for rubber, for dry cell, etc.), may be used as long as dispersibility, etc. in the resin composition for laser engraving is stable. Examples of the carbon black include furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products. Examples of carbon black include carbon blacks described in paragraphs 0130 to 0134 of JP-A-2009-178869.

The photothermal conversion agent in the resin composition of the present invention may be used singly or in a combination of two or more compounds.

The content of the photothermal conversion agent in the resin composition for laser engraving of the present invention may vary greatly with the magnitude of the molecular extinction coefficient inherent to the molecule, but the content is preferably 0.01 to 30 wt %, more preferably 0.05 to 20 wt %, and particularly preferably 0.1 to 10 wt %, relative to the total weight of the resin composition.

Various types of Components contained in the resin composition for laser engraving of the present invention other than Components A to D are explained below.

### <Plasticizer>

The resin composition for laser engraving of the present invention may comprise a plasticizer.

A plasticizer has the function of softening a film formed from the resin composition for laser engraving, and it is necessary for it to be compatible with a binder polymer.

Preferred examples of the plasticizer include dioctyl phthalate, didodecyl phthalate, bisbutoxyethyl adipate, a polyethylene glycol, and a polypropylene glycol (monool type or diol type).

Among them, bisbutoxyethyl adipate is particularly preferable.

With regard to the plasticizer in the resin composition of the present invention, one type thereof may be used on its own or two or more types may be used in combination.

### <Solvent>

It is preferably to use a solvent when preparing the resin composition for laser engraving of the present invention.

As the solvent, an organic solvent is preferably used.

Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

Among these, propylene glycol monomethyl ether acetate is preferable.

### <Other Additives>

The resin composition for laser engraving of the present invention may comprise as appropriate various types of known additives as long as the effects of the present invention are not inhibited. Examples include a filler, a wax, a process oil, an a metal oxide, an antiozonant, an anti-aging agent, a thermopolymerization inhibitor, and a colorant, and one type thereof may be used on its own or two more types may be used in combination.

As the filler, inorganic particles can be cited, and silica particles can be preferably cited.

The inorganic particles preferably have a number-average particle size of at least 0.01 μm but no greater than 10 μm. Furthermore, the inorganic particles are preferably porous particles or nonporous particles.

The porous particles referred to here are defined as particles having fine pores having a pore volume of at least 0.1 mL/g in the particle or particles having fine cavities.

The porous particles preferably have a specific surface area of at least 10 m²/g but no greater than 1,500 m²/g, an average pore diameter of at least 1 nm but no greater than 1,000 nm, a pore volume of at least 0.1 mL/g but no greater than 10 mL/g, and an oil adsorption of at least 10 mL/100 g but no greater than 2,000 mL/100 g. The specific surface area is determined based on the BET equation from the adsorption isotherm of nitrogen at −196° C. Furthermore, measurement of the pore volume and the average pore diameter preferably employs a nitrogen adsorption method. Measurement of the oil adsorption may be suitably carried out in accordance with JIS-K5101.

The number-average particle size of the porous particles is preferably at least 0.01 μm but no greater than 10 μm, more preferably at least 0.5 μm but no greater than 8 μm, and yet more preferably at least 1 μm but no greater than 5 μm.

The shape of the porous particles is not particularly limited, and spherical, flat-shaped, needle-shaped, or amorphous particles, or particles having projections on the surface, etc. may be used.

Furthermore, particles having a cavity in the interior, spherical granules having a uniform pore diameter such as a silica sponge, etc. may be used. Examples thereof are not particularly limited but include porous silica, mesoporous silica, a silica-zirconia porous gel, porous alumina, and a porous glass. Furthermore, as for a layered clay compound, pore diameter cannot be defined for those having a cavity of a few nm to a few hundred nm between layers, and in the present embodiment the distance between cavities present between layers is defined as the pore diameter.

Moreover, particles obtained by subjecting the surface of porous particles to a surface modifying treatment by covering with a silane coupling agent, a titanium coupling agent, or another organic compound so as to make the surface hydrophilic or hydrophobic may also be used. With regard to these porous particles, one type or two or more types may be selected.

The nonporous particles are defined as particles having a pore volume of less than 0.1 mL/g. The number-average particle size of the nonporous particles is the number-average particle size for primary particles as the target, and is preferably at least 10 nm but no greater than 500 nm, and more preferably at least 10 nm but no greater than 100 nm.

The amount of filler added is not particularly limited, but is preferably 1 to 100 parts by mass relative to 100 parts by mass of Component A.

### (Flexographic Printing Plate Precursor for Laser Engraving)

A first embodiment of the flexographic printing plate precursor for laser engraving of the present invention comprises a relief-forming layer formed from the resin composition for laser engraving of the present invention.

A second embodiment of the flexographic printing plate precursor for laser engraving of the present invention comprises a crosslinked relief-forming layer formed by crosslinking a relief-forming layer formed from the resin composition for laser engraving of the present invention.

In the present invention, the ‘flexographic printing plate precursor for laser engraving’ means both or one of a flexographic printing plate precursor having a crosslinkable relief-forming layer formed from the resin composition for laser engraving in a state before being crosslinked and a flexographic printing plate precursor in a state in which it is cured by light or heat.

The flexographic printing plate precursor for laser engraving of the present invention is a flexographic printing plate precursor having a crosslinkable relief-forming layer cured by heat.

In the present invention, the ‘relief-forming layer’ means a layer in a state before being crosslinked, that is, a layer formed from the resin composition for laser engraving of the present invention, which may be dried as necessary.

In the present invention, the “crosslinked relief-forming layer” refers to a layer obtained by crosslinking the aforementioned relief-forming layer. The crosslinking can be performed by light and/or heat, and the crosslinking by heat is preferable. Moreover, the crosslinking is not particularly limited only if it is a reaction that cures the resin composition, and is a general idea that includes the crosslinked structure by the reaction of Component B with each other, and the reaction of Component B with other Component such as Component A etc. The ‘flexographic printing plate’ is made by laser engraving the flexographic printing plate precursor having the crosslinked relief-forming layer.

Moreover, in the present invention, the ‘relief layer’ means a layer of the flexographic printing plate formed by engraving using a laser, that is, the crosslinked relief-forming layer after laser engraving.

A flexographic printing plate precursor for laser engraving of the present invention comprises a relief-forming layer formed from the resin composition for laser engraving of the present invention, which has the above-mentioned components. The relief-forming layer is preferably provided above a support.

The flexographic printing plate precursor for laser engraving may further comprise, as necessary, an adhesive layer between the support and the relief-forming layer and, above the relief-forming layer, a slip coat layer and a protection film.

### <Relief-Forming Layer>

The relief-forming layer is a layer formed from the resin composition for laser engraving of the present invention, and is preferably crosslinkable by heat.

As a mode in which a flexographic printing plate is prepared using the flexographic printing plate precursor for laser engraving, a mode in which a flexographic printing plate is prepared by crosslinking a relief-forming layer to thus form a flexographic printing plate precursor having a crosslinked relief-forming layer, and the crosslinked relief-forming layer (hard relief-forming layer) is then laser-engraved to thus form a relief layer is preferable. By crosslinking the relief-forming layer, it is possible to prevent abrasion of the relief layer during printing, and it is possible to obtain a flexographic printing plate having a relief layer with a sharp shape after laser engraving.

The relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate producing or printing or may be placed and immobilized thereon, and a support is not always required.

A case in which the relief-forming layer is mainly formed in a sheet shape is explained as an example below.

### <Support>

A material used for the support of the flexographic printing plate precursor for laser engraving is not particularly limited, but one having high dimensional stability is preferably used, and examples thereof include metals such as steel, stainless steel, or aluminum, plastic resins such as a polyester (e.g. polyethylene terephthalate (PET), polybutylene terephthalate (PBT), or polyacrylonitrile (PAN)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

### <Adhesive Layer>

An Adhesive Layer May be provided between the relief-forming layer and the support for the purpose of strengthening the adhesion between the two layers. Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### <Process for Producing Flexographic Printing Plate Precursor for Laser Engraving>

The process for producing a flexographic printing plate precursor for laser engraving is not particularly limited, and examples thereof include a method in which a coating solution of a resin composition for laser engraving is prepared, solvent is removed from this coating solution composition for laser engraving, and it is then melt-extruded onto a support. Alternatively, a method may be employed in which a resin composition for laser engraving is cast onto a support, and this is dried in an oven to thus remove solvent from the resin composition.

Among them, the process for producing a flexographic printing plate precursor for laser engraving of the present invention is preferably a production process comprising a layer formation step of forming a relief-forming layer from the resin composition for laser engraving of the present invention and a crosslinking step of crosslinking the relief-forming layer by means of heat and/or light to thus obtain a flexographic printing plate precursor having a crosslinked relief-forming layer, and more preferably a production process comprising a layer formation step of forming a relief-forming layer from the resin composition for laser engraving of the present invention and a crosslinking step of crosslinking the relief-forming layer by means of heat to thus obtain a flexographic printing plate precursor having a crosslinked relief-forming layer.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### <Layer Formation Step>

The process for producing the flexographic printing plate precursor for laser engraving of the present invention preferably comprises a layer formation step of forming a relief-forming layer from the resin composition for laser engraving of the present invention.

Preferred examples of a method for forming the relief-forming layer include a method in which the resin composition for laser engraving of the present invention is prepared, solvent is removed as necessary from this resin composition for laser engraving, and it is then melt-extruded onto a support and a method in which the resin composition for laser engraving of the present invention is cast onto a support, and this is dried in an oven to thus remove solvent.

The resin composition for laser engraving may be preferably produced by, for example, dissolving or dispersing Components A to C, and optional components in an appropriate solvent.

The thickness of the relief-forming layer in the flexographic printing plate precursor for laser engraving is preferably 0.05 to 10 mm before and after crosslinking, more preferably 0.05 to 7 mm, and yet more preferably 0.05 to 3 mm.

### <Crosslinking Step>

The process for producing a flexographic printing plate precursor for laser engraving of the present invention is preferably a production process comprising a crosslinking step of crosslinking the relief-forming layer by means of heat to thus obtain a flexographic printing plate precursor having a crosslinked relief-forming layer.

When the relief-forming layer comprises a photopolymerization initiator, the relief-forming layer may be crosslinked by irradiating the relief-forming layer with actinic radiation that triggers the photopolymerization initiator.

It is preferable to apply light to the entire surface of the relief-forming layer. Examples of the light (also called ‘actinic radiation’) include visible light, UV light, and an electron beam, but UV light is most preferably used. When the side where there is a substrate, such as a relief-forming layer support, for fixing the relief-forming layer, is defined as the reverse face, only the front face need to be irradiated with light, but when the support is a transparent film through which actinic radiation passes, it is preferable to further irradiate from the reverse face with light as well. When a protection film is present, irradiation from the front face may be carried out with the protection film as it is or after peeling off the protection film. Since there is a possibility of polymerization being inhibited in the presence of oxygen, irradiation with actinic radiation may be carried out after superimposing a polyvinyl chloride sheet on the relief-forming layer and evacuating.

When the relief-forming layer comprises thermal polymerization initiator (the photopolymerization initiator can also be a thermal polymerization initiator.), the relief-forming layer may be crosslinked by heating the flexographic printing plate precursor for laser engraving (step of crosslinking by means of heat). As heating means for carrying out crosslinking by heat, there can be cited a method in which a printing plate precursor is heated in a hot air oven or a far-infrared oven for a predetermined period of time and a method in which it is put into contact with a heated roller for a predetermined period of time.

As a method for crosslinking the relief-forming layer, from the viewpoint of the relief-forming layer being uniformly curable (crosslinkable) from the surface into the interior, crosslinking by heat is preferable.

Due to the relief-forming layer being crosslinked, firstly, a relief formed after laser engraving becomes sharp and, secondly, tackiness of engraving residue formed when laser engraving is suppressed. If an uncrosslinked relief-forming layer is laser-engraved, residual heat transmitted to an area around a laser-irradiated part easily causes melting or deformation of a part that is not targeted, and a sharp relief layer cannot be obtained in some cases. Furthermore, in terms of general properties of a material, the lower the molecular weight, the more easily it becomes a liquid than a solid, that is, there is a tendency for tackiness to increase. Engraving residue formed when engraving a relief-forming layer tends to have higher tackiness as larger amounts of low-molecular-weight materials are used. Since a polymerizable compound, which is a low-molecular-weight material, becomes a polymer by crosslinking, the tackiness of the engraving residue formed tends to decrease.

When the crosslinking step is a step of carrying out crosslinking by light, although equipment for applying actinic radiation is relatively expensive, since a printing plate precursor does not reach a high temperature, there are hardly any restrictions on starting materials for the printing plate precursor.

When the crosslinking step is a step of carrying out crosslinking by heat, although there is the advantage that particularly expensive equipment is not needed, since a printing plate precursor reaches a high temperature, it is necessary to carefully select the starting materials used while taking into consideration the possibility that a thermoplastic polymer, which becomes soft at high temperature, will deform during heating, etc.

During thermal crosslinking, it is preferable to add a thermopolymerization initiator. As the thermopolymerization initiator, a commercial thermopolymerization initiator for free radical polymerization may be used. Examples of such a thermopolymerization initiator include an appropriate peroxide, hydroperoxide, and azo group-containing compound. A representative vulcanizing agent may also be used for crosslinking. Thermal crosslinking may also be carried out by adding a heat-curable resin such as for example an epoxy resin as a crosslinking component to a layer.

### (Flexographic Printing Plate and Process for Making Same)

The process for making a flexographic printing plate of the present invention preferably comprises an engraving step of laser-engraving the flexographic printing plate precursor having the crosslinked relief-forming layer crosslinked the relief-forming layer from the resin composition for laser engraving of the present invention by means of heat and/or light, and more preferably comprises an engraving step of laser-engraving the flexographic printing plate precursor having the crosslinked relief-forming layer crosslinked the relief-forming layer from the resin composition for laser engraving of the present invention by means of heat.

The flexographic printing plate of the present invention is a flexographic printing plate having a relief layer obtained by crosslinking and laser-engraving a layer formed from the resin composition for laser engraving of the present invention, and is preferably a flexographic printing plate made by the process for producing a flexographic printing plate of the present invention.

The flexographic printing plate of the present invention may suitably employ an aqueous ink when printing.

The layer formation step and the crosslinking step in the process for producing a flexographic printing plate of the present invention mean the same as the layer formation step and the crosslinking step in the above-mentioned process for producing a flexographic printing plate precursor for laser engraving, and preferred ranges are also the same.

### <Engraving Step>

The process for producing a flexographic printing plate of the present invention preferably comprises an engraving step of laser-engraving the flexographic printing plate precursor having a crosslinked relief-forming layer.

The engraving step is a step of laser-engraving a crosslinked relief-forming layer that has been crosslinked in the crosslinking step to thus form a relief layer. Specifically, it is preferable to engrave a crosslinked relief-forming layer that has been crosslinked with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser (an IR laser). When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser (a CO₂ laser) or a semiconductor laser is preferable. In particular, a fiber-coupled semiconductor infrared laser (FC-LD) is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is yet more preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, Applied Laser Technology, The Institute of Electronics and Communication Engineers, etc.

Moreover, as plate making equipment comprising a fiber-coupled semiconductor laser that can be used suitably in the process for making a flexographic printing plate employing the flexographic printing plate precursor of the present invention, those described in detail in JP-A-2009-172658 and JP-A-2009-214334 can be cited. Such equipment comprising a fiber-coupled semiconductor laser can be used to produce a flexographic printing plate of the present invention.

The process for producing a flexographic printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid comprising water as a main component.

Drying step: a step of drying the engraved relief layer.

Post-crosslinking step: a step of further crosslinking the relief layer by applying energy to the engraved relief layer.

After the above-mentioned step, since engraved residue is attached to the engraved surface, a rinsing step of washing off engraved residue by rinsing the engraved surface with water or a liquid comprising water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraved residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.5, and yet more preferably no greater than 13.2. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraved residue and little influence on a flexographic printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 mass % relative to the total mass of the rinsing liquid, and more preferably 0.05 to 10 mass %.

The flexographic printing plate of the present invention having a relief layer above the surface of an optional substrate such as a support may be produced as described above.

From the viewpoint of satisfying suitability for various aspects of printing, such as abrasion resistance and ink transfer properties, the thickness of the relief layer of the flexographic printing plate is preferably at least 0.05 mm but no greater than 10 mm, more preferably at least 0.05 mm but no greater than 7 mm, and yet more preferably at least 0.05 mm but no greater than 3 mm.

Furthermore, the Shore A hardness of the relief layer of the flexographic printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target at 25° C. so as to deform it, measures the amount of deformation (indentation depth), and converts it into a numerical value.

The flexographic printing plate of the present invention is particularly suitable for printing by a flexographic printer using an aqueous ink, but printing is also possible when it is carried out by a letterpress printer using any of aqueous, oil-based, and UV inks, and printing is also possible when it is carried out by a flexographic printer using a UV ink. The flexographic printing plate of the present invention has excellent rinsing properties, there is no engraved residue, and has excellent printing durability, and printing can be carried out for a long period of time without plastic deformation of the relief layer or degradation of printing durability.

In accordance with the present invention, there can be provided a resin composition for laser engraving that can give a flexographic printing plate having high engraving sensitivity, good rinsing properties for engraving residue, and excellent printing durability and swelling inhibition properties for an aqueous ink and a solvent ink, a flexographic printing plate precursor employing the resin composition for laser engraving and a process for producing same, a process for making a flexographic printing plate using same, and a flexographic printing plate obtained thereby.

### EXAMPLES

The present invention is explained in further detail below by reference to Examples, but the present invention should not be construed as being limited to these Examples. Furthermore, ‘parts’ in the description below means ‘parts by mass’, and ‘%’ means ‘% by mass’, unless otherwise specified.

Moreover, the number-average molecular weight (Mn) and the weight-average molecular weight (Mw) of a polymer in the Examples are values measured by a GPC method unless otherwise specified.

### <Synthesis of A-1>

Using, as MI-1, (MI is an abbreviation for Macroinitiator) VPS-1001 (polydimethylsiloxane unit-containing macro azo initiator, Wako Pure Chemical Industries, Ltd.), n-butyl acrylate was polymerized in toluene (polymerization concentration 30 mass %) at 85° C. for 8 hours, and the target block copolymer A-1 was obtained by distilling off the solvent (Mw=150,000).

### <Synthesis of A-2>

Using, as MI-2, VPE-0401 (polyethylene glycol unit-containing macro azo initiator, Wako Pure Chemical Industries, Ltd.), styrene and n-butyl acrylate (molar ratio 1:2) were polymerized in methyl ethyl ketone (polymerization concentration 30 mass %) at 90° C. for 7 hours, and the target block copolymer A-2 was obtained by distilling off the solvent (Mw=110,000).

### <Synthesis of A-3>

Using MI-3 below, n-butyl acrylate was polymerized in methyl ethyl ketone (polymerization concentration 30 mass %) at 130° C. for 24 hours, thus giving block copolymer A-3 (Mw=88,000).

MI-3: polyurethane resin obtained by polycondensation of disulfide-containing diol (below), polypropylene glycol diol (number-average molecular weight 1,000, hereinafter abbreviated to PPG-1000), and 4,4′-diphenylmethane diisocyanate (hereinafter, abbreviated to MDI) at 20:30:50 (molar ratio) in methyl ethyl ketone (polymerization concentration 10 mass %) at 50° C. for 5 hours (Mw=22,000).

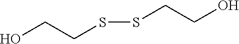

### <Synthesis of A-4>

Using MI-4 below, n-butyl acrylate was polymerized in methyl ethyl ketone (polymerization concentration 30 mass %) at 90° C. for 8 hours, and the target block copolymer A-4 was obtained by distilling off the solvent (Mw=150,000).

MI-4: 15.0 parts of the diamine compound shown below and 34.6 parts of N,N′-bis(3-aminophenyl)isophthalamide were dissolved in 375 parts of dimethylacetamide purified by distillation, subsequently 15.2 parts of isophthaloyl chloride and 4 parts of triethylamine were added, and a reaction was carried out at 10° C. to 15° C. for 4 hours. After the reaction was completed the mixture was poured into water to thus precipitate a macro compound. The macro compound thus precipitated was washed with methanol twice and diethyl ether twice, and dried at 25° C. under vacuum, thus giving MI-4 (Mw=15,000).

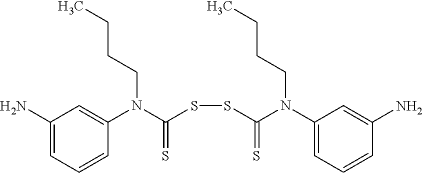 [SMILES: CCCCN(C(=S)SSC(=S)N(CCCC)c1cccc(N)c1)c1cccc(N)c1]

### <Synthesis of A-5>

Using MI-5 below, n-butyl acrylate was polymerized in methyl ethyl ketone (polymerization concentration 30 mass %) at 120° C. for 24 hours, thus giving block copolymer A-5 (Mw=98,000).

MI-5: a solution of a polyester resin was produced by polycondensation of an alkoxyamine diol (below), 1,7-heptanediol, and adipic acid at 20:30:50 (molar ratio) in methyl ethyl ketone (polymerization concentration 45 mass %) at 40° C. for 24 hours, and the target resin was obtained by distilling off the solvent (Mw=12.000).

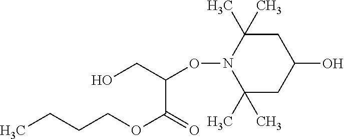 [SMILES: CCCCOC(=O)C(CO)ON1C(C)(C)CC(O)CC1(C)C]

### <Synthesis of A-6>

Using MI-6 below, n-butyl acrylate was polymerized, thus giving block copolymer A-6 (Mw=96,000).

MI-6: a solution of a polyurethane resin was produced by polyaddition of an alkoxyamine diol (below), siloxanediol (Shin-Etsu Chemical Co., Ltd.), and MDI at 20:30:50 (molar ratio) in methyl ethyl ketone (polymerization concentration 15 mass %) at 30° C. for 24 hours, and the target resin was obtained by distilling off the solvent (Mw=18,000).

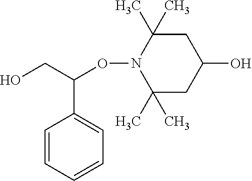 [SMILES: CC1(C)CC(O)CC(C)(C)N1OC(CO)c1ccccc1]

### <Synthesis of A-7>

Using MI-7 below, n-butyl acrylate and styrene were polymerized at a molar ratio of 2:1 in N,N-dimethylacetamide (polymerization concentration 30 mass %) at 120° C. for 24 hours, thus giving block copolymer A-7 (Mw=105,000).

MI-7: a flask flushed with nitrogen was charged with 4.6 parts of benzopinacol and 1.3 parts of di-n-butyltin dilaurate, which were then dissolved in 178.7 parts of 1-methyl-2-pyrrolidone. Subsequently, 18.8 parts of 1,3-bis(isocyanatomethyl)benzene was poured into this solution at 25° C., and they were reacted at a reaction temperature of 25° C. for 24 hours, thus giving a solution of an isocyanate compound. A reaction vessel formed from a flask preflushed with nitrogen and a dropping funnel was prepared, the dropping funnel was charged with the solution of the isocyanate compound, the flask was charged with 8.1 parts of 1,4-butanediol, and the solution of the isocyanate compound was added dropwise over 2 hours at a polymerization temperature of 60° C. Subsequently, the liquid temperature of the reaction solution was increased to 80° C. and a reaction was carried out for 1 hour, thus giving a solution of the target MI-7 (Mw=20,000). The solution thus obtained was poured into 890 parts of methanol, thus precipitating the MI-7, followed by filtration, and the MI-7 was washed on a filter paper using 445 parts of methanol. Subsequently, the MI-7 was isolated by drying under vacuum at room temperature for 24 hours.

### <Synthesis of A-8>

Using MI-8 below, acrylonitrile was polymerized in N,N-dimethylacetamide (polymerization concentration 40 mass %) at 120° C. for 24 hours, thus giving block copolymer A-8 (Mw=95,000).

MI-8: a flask flushed with nitrogen was charged with 0.8 parts (0.0023 molar equivalents) of benzopinacol and 1.3 parts (0.002 molar equivalents) of di-n-butyltin dilaurate, which were then dissolved in 162.6 parts of 1-methyl-2-pyrrolidone. Subsequently, 18.8 parts (0.1 molar equivalents) of 1,3-bis(isocyanatomethyl)benzene was poured into this solution at 25° C., and they were reacted at a reaction temperature of 25° C. for 24 hours, thus giving a solution of an isocyanate compound. A reaction vessel formed from a flask preflushed with nitrogen and a dropping funnel was prepared, the dropping funnel was charged with the solution of the isocyanate compound, the flask was charged with 0.03 molar equivalents of X-22-160AS (both termini carbinol-modified silicone oil, Shin-Etsu Chemical Co., Ltd.) and 0.07 molar equivalents of 1,4-butanediol, and the solution of the isocyanate compound was added dropwise over 2 hours at a polymerization temperature of 60° C. Subsequently, the liquid temperature of the reaction solution was increased to 80° C. and a reaction was carried out for 1 hour, thus giving a solution of the target MI-8 (Mw=32,000). The solution thus obtained was poured into 890 parts of methanol, thus precipitating the MI-8, followed by filtration, and the MI-8 was washed on a filter paper using 445 parts of methanol. Subsequently, the MI-8 was isolated by drying under vacuum at room temperature for 24 hours.

### <Synthesis of A-9>

Using MI-9 below, n-butyl acrylate was polymerized in methyl ethyl ketone (polymerization concentration 30 mass %) at 130° C. for 24 hours, thus giving block copolymer A-9 (Mw=96,000).

MI-9: a disulfide-containing diol (below), KF-6003 (both termini carbinol-modified silicone oil, Shin-Etsu Chemical Co., Ltd.), and 4,4′-diphenylmethane diisocyanate (hereinafter, abbreviated to MDI) were polycondensed at 20:30:50 (molar ratio) in methyl ethyl ketone (polymerization concentration 10 mass %) at 50° C. for 5 hours, and after the reaction was completed the mixture was poured into water to thus precipitate a macro compound. The macro compound thus precipitated was washed with methanol twice and diethyl ether twice and dried under vacuum at 25° C., thus giving MI-9 (Mw=26,000).

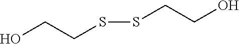

### <Synthesis of A-10>

Using MI-10 below, n-butyl acrylate was polymerized in methyl ethyl ketone (polymerization concentration 30 mass %) at 90° C. for 8 hours, and the solvent was distilled off, thus giving block copolymer A-10 (Mw=115,000).

MI-10: the diamine compound shown below, X-22-161A (both termini amino-modified silicone oil, Shin-Etsu Chemical Co., Ltd.), and isophthaloyl chloride were reacted at 20:30:50 (molar ratio) with 4 parts of triethylamine added at 10° C. to 15° C. for 4 hours. After the reaction was completed the mixture was poured into water, thus precipitating a macro compound. The macro compound thus precipitated was washed with methanol twice and diethyl ether twice, and dried under vacuum at 25° C. to thus give MI-10 (Mw=20.000).

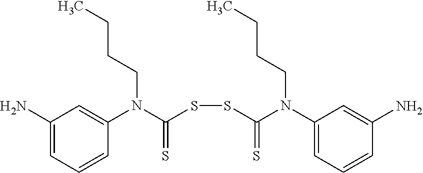 [SMILES: CCCCN(C(=S)SSC(=S)N(CCCC)c1cccc(N)c1)c1cccc(N)c1]

### <Synthesis of A-11>

Using MI-11 below, n-butyl acrylate was polymerized in methyl ethyl ketone (polymerization concentration 30 mass %) at 120° C. for 24 hours, thus giving block copolymer A-11 (Mw=78,000).

MI-11: an alkoxyamine diol (below), 1,7-heptanediol, and adipoyl chloride were polycondensed at 20:30:50 (molar ratio) in methyl ethyl ketone (polymerization concentration 45 mass %) at 40° C. for 24 hours, and after the reaction was completed the mixture was poured into water, thus precipitating a macro compound. The macro compound thus precipitated was washed with methanol twice and diethyl ether twice, and dried under vacuum at 25° C., thus giving MI-11 (Mw=27,000).

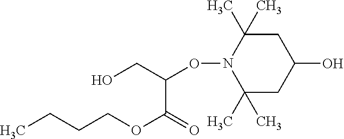 [SMILES: CCCCOC(=O)C(CO)ON1C(C)(C)CC(O)CC1(C)C]

### <Synthesis of A-12>

Using MI-12 below, acrylonitrile was polymerized in N,N-dimethylacetamide (polymerization concentration 40 mass %) at 120° C. for 24 hours, thus giving block copolymer A-12 (Mw=85,000).

MI-12: synthesized by the same procedure as for MI-8 except that the step-growth polymerizable monomers were changed to benzopinacol:1,3-bis(isocyanatomethyl)benzene:1,4-butanediol:KF-6003 (both termini carbinol-modified silicone oil, Shin-Etsu Chemical Co., Ltd.)=5:50:30:20 (molar ratio), and MI-12 (Mw=21,000) was isolated.

### <Synthesis of P-1>

A flask flushed with nitrogen was charged with 1.3 parts (0.002 molar equivalents) of di-n-butyltin dilaurate, which was then dissolved in 162.6 parts of 1-methyl-2-pyrrolidone. Subsequently, 18.8 parts (0.1 molar equivalents) of 1,3-bis(isocyanatomethyl)benzene was poured into this solution at 25° C., and they were reacted at a reaction temperature of 25° C. for 24 hours, thus giving a solution of an isocyanate compound. A reaction vessel formed from a flask preflushed with nitrogen and a dropping funnel was prepared, the dropping funnel was charged with the solution of the isocyanate compound, the flask was charged with 9.0 parts (0.1002 molar equivalents) of 1,4-butanediol, and the solution of the isocyanate compound was added dropwise over 2 hours at a polymerization temperature of 60° C. Subsequently, the liquid temperature of the reaction solution was increased to 80° C., a reaction was carried out for 1 hour thus producing a solution of P-1, and the solvent was distilled off to give P-1 (Mw=90,000).

### Example 1

### 1. Preparation of Resin Composition for Laser Engraving

A three-necked flask equipped with a stirring blade and a condenser was charged with 50 parts of A-1 as Component A and, as a solvent, 200 parts of N,N-dimethylacetamide, and heated at 40° C. for 120 minutes while stirring to thus dissolve the polymer. Subsequently, the solution was set at 70° C., 25 parts of 1,6-hexanediol diacrylate as a polymerizable compound (Component B) and 0.5 parts of t-butylperoxybenzoate (product name: Perbutyl Z, NOF Corporation) as a polymerization initiator (Component C) were added, and stirring was carried out for 30 minutes. As a result of the above operations, flowable coating solution 1 for a crosslinkable relief-forming layer (resin composition 1 for laser engraving) was obtained.

### 2. Preparation of Flexographic Printing Plate Precursor for Laser Engraving

A spacer (frame) having a predetermined thickness was placed on a PET substrate, and the coating solution 1 for a crosslinkable relief-forming layer obtained above was cast gently so that it did not overflow from the spacer (frame) and dried in an oven at 70° C. for 3 hours. Subsequently, heating was carried out at 80° C. for 3 hours and at 100° C. for a further 3 hours to thus thermally crosslink the relief-forming layer to provide a relief-forming layer having a thickness of about 1 mm, thereby preparing flexographic printing plate precursor 1 for laser engraving.

### 3. Making Flexographic Printing Plate

The relief-forming layer after crosslinking (crosslinked relief-forming layer) was engraved using the two types of laser below.

As a carbon dioxide laser engraving machine, for engraving by irradiation with a laser, an ML-9100 series high quality CO₂ laser marker (Keyence) was used. A 1 cm square solid printed part was raster-engraved using the carbon dioxide laser engraving machine under conditions of an output of 12 W, a head speed of 200 mm/sec, and a pitch setting of 2,400 DPI.

As a semiconductor laser engraving machine, laser recording equipment provided with an SDL-6390 fiber-coupled semiconductor laser (FC-LD) (JDSU, wavelength 915 nm) with a maximum power of 8.0 W was used. A 1 cm square solid printed part was raster-engraved using the semiconductor laser engraving machine under conditions of a laser output of 7.5 W, a head speed of 409 mm/sec, and a pitch setting of 2,400 DPI.

The thickness of the relief layer of the flexographic printing plate was about 1 mm.

Furthermore, the Shore A hardness of the relief layer measured by the measurement method above was 75°.

### Examples 2 to 20 and Comparative Examples 1 to 6

### 1. Preparation of Crosslinkable Resin Compositions for Laser Engraving

Coating solutions for a crosslinkable relief-forming layer (resin compositions for laser engraving) 2 to 10 and comparative coating solutions for a crosslinkable relief-forming layer (resin compositions for laser engraving) 1 to 6 were prepared in the same manner as for Example 1 except that Component A to Component C used in Example 1 and Component D below were changed as in Table 1 below. In addition, carbon black (Ketjen Black EC600JD, Lion Corporation), which is a photothermal conversion agent (Component D), was added at 1 part together with Component B and Component C.

Furthermore, in Examples 11 to 16 and 20 and Comparative Example 6, when two types of compounds were used in combination as one component, for each of the components the total amount added was not changed from the amount added in Example 1 described above, and the two types of compounds were added at a ratio by mass of 1:1. Specifically, for example, in Example 11, as Component B 1,6-hexanediol diacrylate was added at 12.5 parts and KBM-803 was added at 12.5 parts, and as Component C Perbutyl Z was added at 0.25 parts and DBU was added at 0.25 parts.

### 2. Preparation of Flexographic Printing Plate Precursors for Laser Engraving

Flexographic printing plate precursors 2 to 20 for laser engraving of the Examples and flexographic printing plate precursors 1 to 6 for laser engraving of the Comparative Examples were prepared in the same manner as in Example 1 except that coating solution 1 for a crosslinkable relief-forming layer in Example 1 was changed to coating solutions 2 to 20 for a crosslinkable relief-forming layer and comparative coating solutions 1 to 6 for a crosslinkable relief-forming layer.

### 3. Preparation of Flexographic Printing Plates

Flexographic printing plates 2 to 20 of the Examples and flexographic printing plates 1 to 6 of the Comparative Examples were obtained by subjecting the relief-forming layers of flexographic printing plate precursors 2 to 20 for laser engraving of the Examples and flexographic printing plate precursors 1 to 6 for laser engraving of the Comparative Examples to thermal crosslinking and then engraving to form a relief layer as in Example 1.

The thickness of the relief layers of these flexographic printing plates was about 1 mm.

Furthermore, the Shore A hardness of the relief layer measured by the measurement method above was 75°.

### <Evaluation of Flexographic Printing Plates>

Evaluation of the performance of the flexographic printing plates was carried out in terms of the items below, and the results are shown in Table 1. With regard to evaluations other than engraving depth, the evaluation results when engraving was carried out using a carbon dioxide laser and the evaluation results when engraving was carried out using a semiconductor laser were the same.

### (1) Percentage Swelling

A film was cut into a 1 cm×1 cm square size and immersed in an ink at room temperature (25° C.) for 24 hours. Percentage swelling was calculated by the equation below using the mass before the immersion and the mass thereafter. As the ink, an aqueous ink (Aqua SPZ16 Red, Toyo Ink Co., Ltd.) was used without dilution or a solvent ink (XS-716 507 Blue, DIC GRAPHICS CORPORATION) was used.

The percentage swelling is an index in which the smaller the value the greater the resistance to swelling, and in the present invention the closer it is to 100% the better.

Percentage swelling (%)=100×mass after immersion in ink/mass before immersion in ink

### (2) Printing Durability

A relief printing plate that had been obtained was set in a printer (Model ITM-4, IYO KIKAI SEISAKUSHO Co., Ltd.). As the ink, an aqueous ink (Aqua SPZ16 Red aqueous ink, Toyo Ink Manufacturing Co., Ltd.) was used without dilution or a solvent ink (XS-716 507 Blue, DIC GRAPHICS CORPORATION) was used. Printing was carried out continuously using Full Color Form M 70 (Nippon Paper Industries Co., Ltd., thickness 100 μm) as the printing paper, and a highlight of 1% to 10% was confirmed for a printed material. The end of printing was defined as being when there was a halftone dot that was not printed, and the length (meters) of paper that was printed up to the end of printing was used as an index. The larger the value, the better the printing durability.

### (3) Measurement of Engraving Depth

The ‘engraving depth’ of a relief layer obtained by laser-engraving the relief-forming layer of the obtained flexographic printing plate precursors using a carbon dioxide laser or a semiconductor laser (IR laser) was measured as follows. The ‘engraving depth’ referred to here means the difference between an engraved position (height) and an unengraved position (height) when a cross-section of the relief layer was examined. The ‘engraving depth’ in the present Examples was measured by examining a cross-section of a relief layer using a VK9510 ultradepth color 3D profile measurement microscope (Keyence Corporation). A large engraving depth means a high engraving sensitivity. The results are given in Table 1 for each of the types of laser used for engraving.

### (4) Rinsing Properties

A laser-engraved plate was immersed in water and an engraved part was rubbed with a toothbrush (Clinica Toothbrush Flat, Lion Corporation) 10 times. Subsequently, the presence/absence of residue on the surface of the relief layer was ascertained with an optical microscope. When there was no residue the evaluation was A, when there was almost no residue the evaluation was B, when there was some residue but there was no practical problem the evaluation was C, and when the residue could not be removed the evaluation was D.

TABLE 1

| | Resin composition components | | | | | | | | | | |
|---|---|---|---|---|---|---|---|---|---|---|---|
| | | | | (Compo- | | | | | | | |
| | | | | nent D) | | | | | Engraving | | |
| | (Compo- | (Compo- | (Compo- | photo- | | | | | depth (μm) | | |
| | nent A) | nent B) | nent C) | thermal | Percentage | | | | | IR | Engraving |
| | block | polymeri- | polymeri- | conver- | swelling (%) | | Printing durability | | | laser | residue |
| | copoly- | zable | zation | sion | Aqueous | Solvent | Aqueous | Solvent | CO₂ | (FC- | rinsing |
| | mer | compound | initiator | agent | ink | ink | ink | ink | laser | LD) | properties |
| Ex. 1 | A-1 | 1,6-HDDA | Perbutyl Z | None | 105 | 130 | 50 km | 20 km | 300 | 0 | B |
| Ex. 2 | A-1 | 1,6-HDDA | AIBN | None | 105 | 140 | 40 km | 15 km | 290 | 0 | B |
| Ex. 3 | A-1 | 1,6-HDDA | Perbutyl Z | CB | 105 | 120 | 60 km | 30 km | 330 | 360 | B |
| Ex. 4 | A-2 | 1,6-HDDA | Perbutyl Z | CB | 110 | 125 | 70 km | 30 km | 330 | 360 | B |
| Ex. 5 | A-3 | 1,6-HDDA | Perbutyl Z | CB | 105 | 120 | 70 km | 30 km | 330 | 360 | B |
| Ex. 6 | A-4 | 1,6-HDDA | Perbutyl Z | CB | 105 | 130 | 60 km | 20 km | 320 | 350 | B |
| Ex. 7 | A-5 | 1,6-HDDA | Perbutyl Z | CB | 105 | 120 | 70 km | 35 km | 340 | 370 | B |
| Ex. 8 | A-6 | 1,6-HDDA | Perbutyl Z | CB | 100 | 120 | 70 km | 35 km | 350 | 380 | B |
| Ex. 9 | A-7 | 1,6-HDDA | Perbutyl Z | CB | 100 | 115 | 70 km | 40 km | 350 | 380 | B |
| Ex. 10 | A-8 | 1,6-HDDA | Perbutyl Z | CB | 100 | 110 | 70 km | 43 km | 350 | 380 | B |
| Ex. 11 | A-1 | 1,6-HDDA + | Perbutyl Z + | CB | 100 | 110 | 70 km | 50 km | 350 | 380 | A |
| | | KBM-803 | DBU | | | | | | | | |
| Ex. 12 | A-2 | 1,6-HDDA + | Perbutyl Z + | CB | 100 | 115 | 70 km | 45 km | 350 | 380 | A |
| | | KBM-802 | phosphoric | | | | | | | | |
| | | | acid | | | | | | | | |
| Ex. 13 | A-3 | 1,6-HDDA + | Perbutyl Z + | CB | 100 | 110 | 70 km | 50 km | 350 | 380 | A |
| | | KBM-802 | C-1 | | | | | | | | |
| Ex. 14 | A-6 | 1,6-HDDA + | Perbutyl Z + | CB | 100 | 105 | 90 km | 60 km | 370 | 400 | A |
| | | B-1 | DBU | | | | | | | | |
| Ex. 15 | A-7 | TMPT + | Perbutyl Z + | CB | 100 | 103 | 100 km | 80 km | 380 | 400 | A |
| | | B-1 | DBU | | | | | | | | |
| Ex. 16 | A-8 | TMPT + | Perbutyl Z + | CB | 100 | 100 | 100 km | 82 km | 380 | 405 | A |
| | | B-1 | DBU | | | | | | | | |
| Ex. 17 | A-9 | 1,6-HDDA | Perbutyl Z | CB | 100 | 107 | 75 km | 55 km | 340 | 365 | A |
| Ex. 18 | A-10 | 1,6-HDDA | Perbutyl Z | CB | 100 | 105 | 75 km | 60 km | 340 | 365 | A |
| Ex. 19 | A-11 | 1,6-HDDA | Perbutyl Z | CB | 100 | 103 | 80 km | 80 km | 340 | 380 | A |
| Ex. 20 | A-12 | 1,6-HDDA | Perbutyl Z + | CB | 100 | 103 | 80 km | 82 km | 350 | 380 | A |
| | | | DBU | | | | | | | | |
| COMP | P-1 | 1,6-HDDA | Perbutyl Z | CB | 125 | 300 | 25 km | 0.3 km | 290 | 310 | C |
| Ex. 1 | | | | | | | | | | | |
| COMP | P-2 | 1,6-HDDA | Perbutyl Z | CB | 120 | 220 | 30 km | 0.5 km | 290 | 300 | D |
| Ex. 2 | | | | | | | | | | | |
| COMP | P-3 | 1,6-HDDA | Perbutyl Z | CB | 100 | 130 | 40 km | 12 km | 230 | 250 | D |
| Ex. 3 | | | | | | | | | | | |
| Comp. | P-4 | GDMA | Perbutyl Z | CB | 250 | 105 | 2 km | 50 km | 290 | 300 | B |
| Ex. 4 | | | | | | | | | | | |
| Comp. | P-5 | 1,6-HDDA | Perbutyl Z | CB | 100 | 180 | 40 km | 7 km | 300 | 320 | C |
| Ex. 5 | | | | | | | | | | | |
| Comp. | P-1 + | 1,6-HDDA | Perbutyl Z | CB | 105 | 210 | 40 km | 8 km | 240 | 270 | D |
| Ex. 6 | P-3 | | | | | | | | | | |

The abbreviations in Table 1 are as follows.

A-1 to A-12 and P-1: resins synthesized above
P-2: KURARITY LA2250 (polymethylmethacrylate (PMMA)-b-polybutyl acrylate (PBA)-b-PMMA block copolymer, Kuraray Co., Ltd.)
P-3: TR2000 (synthetic rubber SBR, JSR Corporation)
P-4: Isobam #06 (alkali water-soluble polymer formed by copolymerization of isobutylene and maleic anhydride, Kuraray Co., Ltd.)
P-5: polyurethane resin formed by polymerization of 1,3-bis(isocyanatomethyl)benzene:1,4-butanediol:Blemmer GLM (NOF Corporation, structure shown below)=1:0.3:0.2 by molar ratio

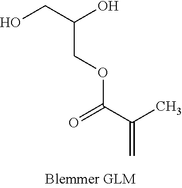

1,6-HDDA: compound below, 1,6-hexanediol diacrylate
TMPT: trimethylolpropane triacrylate
KBM-803: 3-mercaptopropyltrimethoxysilane (Shin-Etsu Chemical Co., Ltd.)
KBM-802: compound below, 3-mercaptopropylmethyldimethoxysilane (Shin-Etsu Chemical Co., Ltd.)
B-1: compound below
GDMA: compound below, glycerol dimethacrylate
Perbutyl Z: compound below, t-butylperoxybenzoate (NOF Corporation)
AIBN: azobisisobutyronitrile
DBU: compound below
C-1: tetraisopropyl orthotitanate
CB: carbon black, Ketjen Black EC600JD (Lion Corporation)

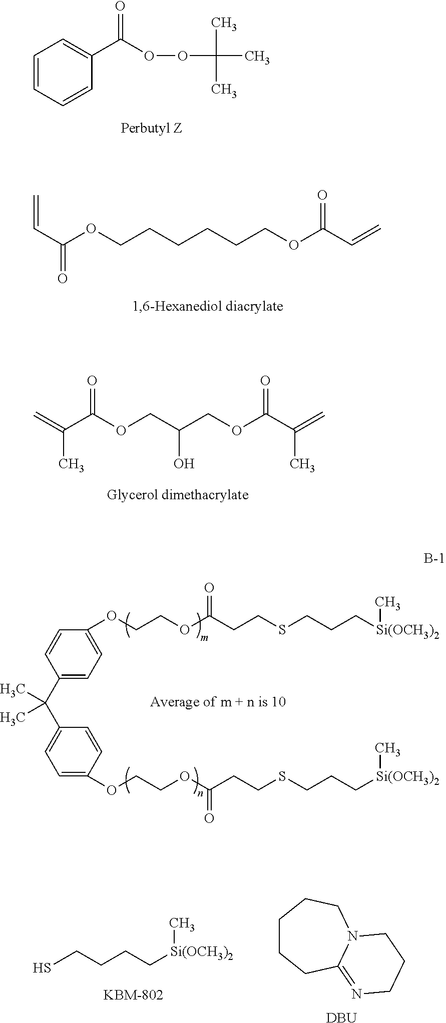

What is claimed is:

1. A resin composition for laser engraving, comprising:
(Component A) a block copolymer comprising a main chain skeleton obtained by step-growth polymerization and a main chain skeleton obtained by chain-growth polymerization;
(Component B) a polymerizable compound; and
(Component C) a polymerization initiator.

2. The resin composition for laser engraving according to claim 1, wherein Component A is a block copolymer comprising a structure selected from the group consisting of structures represented by P-I to P-V and P′-I to P′-V below, 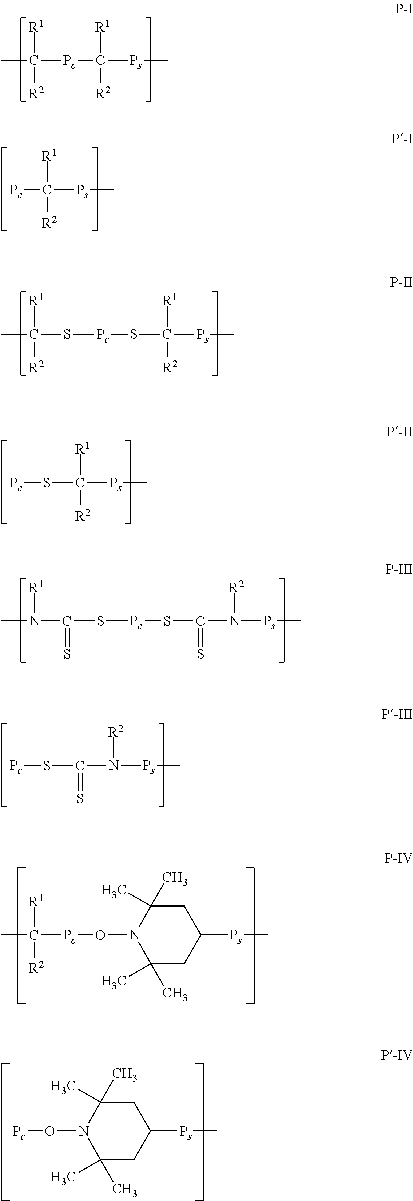 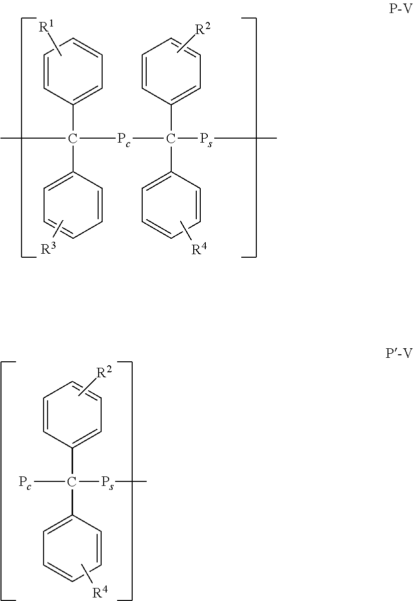
wherein in the Formulae, Ps denotes a main chain skeleton obtained by step-growth polymerization, Pc denotes a main chain skeleton obtained by chain-growth polymerization, and R¹ to R⁴ independently denote a hydrogen atom, a halogen atom, or a monovalent organic group.

3. The resin composition for laser engraving according to claim 1, wherein the main chain skeleton obtained by chain-growth polymerization is a skeleton obtained by chain-growth polymerization of an ethylenically unsaturated compound selected from the group consisting of an acrylic acid ester, a methacrylic acid ester, a styrene, and acrylonitrile.

4. The resin composition for laser engraving according to claim 2, wherein the main chain skeleton obtained by chain-growth polymerization is a skeleton obtained by chain-growth polymerization of an ethylenically unsaturated compound selected from the group consisting of an acrylic acid ester, a methacrylic acid ester, a styrene, and acrylonitrile.

5. The resin composition for laser engraving according to claim 1, wherein the main chain skeleton obtained by step-growth polymerization is a skeleton selected from the group consisting of a polyester skeleton, a polyurethane skeleton, a polyurethane urea skeleton, a polyamide skeleton, a polyalkylene glycol skeleton, and a polysiloxane skeleton.

6. The resin composition for laser engraving according to claim 2, wherein the main chain skeleton obtained by step-growth polymerization is a skeleton selected from the group consisting of a polyester skeleton, a polyurethane skeleton, a polyurethane urea skeleton, a polyamide skeleton, a polyalkylene glycol skeleton, and a polysiloxane skeleton.

7. The resin composition for laser engraving according to claim 4, wherein the main chain skeleton obtained by step-growth polymerization is a skeleton selected from the group consisting of a polyester skeleton, a polyurethane skeleton, a polyurethane urea skeleton, a polyamide skeleton, a polyalkylene glycol skeleton, and a polysiloxane skeleton.

8. The resin composition for laser engraving according to claim 1, wherein Component B comprises a (meth)acrylate derivative and a compound comprising at least one type from a hydrolyzable silyl group and a silanol group.

9. The resin composition for laser engraving according to claim 2, wherein Component B comprises a (meth)acrylate derivative and a compound comprising at least one type from a hydrolyzable silyl group and a silanol group.

10. The resin composition for laser engraving according to claim 4, wherein Component B comprises a (meth)acrylate derivative and a compound comprising at least one type from a hydrolyzable silyl group and a silanol group.

11. The resin composition for laser engraving according to claim 1, wherein Component C comprises an organic peroxide and a silane coupling catalyst.

12. The resin composition for laser engraving according to claim 1, wherein Component B comprises a (meth)acrylate derivative and a compound comprising at least one type from a hydrolyzable silyl group and a silanol group, and Component C comprises an organic peroxide and a silane coupling catalyst.

13. The resin composition for laser engraving according to claim 1, wherein the resin composition further comprises (Component D) a photothermal conversion agent.

14. The resin composition for laser engraving according to claim 13, wherein Component D is carbon black.

15. A flexographic printing plate precursor for laser engraving, comprising a relief-forming layer comprising the resin composition for laser engraving according to claim 1.

16. A flexographic printing plate precursor for laser engraving, comprising a crosslinked relief-forming layer formed by crosslinking by means of light and/or heat a relief-forming layer comprising the resin composition for laser engraving according to claim 1.

17. A process for producing a flexographic printing plate precursor for laser engraving, comprising:
a layer formation step of forming a relief-forming layer comprising the resin composition for laser engraving according to claim 1; and
a crosslinking step of crosslinking the relief-forming layer by means of light and/or heat to thus obtain a flexographic printing plate precursor comprising a crosslinked relief-forming layer.

18. The process for producing a flexographic printing plate precursor for laser engraving according to claim 17, wherein the crosslinking step is a step of crosslinking the relief-forming layer by means of heat to thus obtain a flexographic printing plate precursor comprising a crosslinked relief-forming layer.

19. A process for making a flexographic printing plate, comprising:
an engraving step of laser engraving a flexographic printing plate precursor for laser engraving comprising a crosslinked relief-forming layer formed by crosslinking by means of light and/or heat a relief-forming layer comprising the resin composition for laser engraving according to claim 1, to thus form a relief layer.

20. A flexographic printing plate comprising a relief layer made by the process for making a flexographic printing plate according to claim 19.
